(19) United States
(12) Patent Application Publication
(10) Pub. No.: US 2026/0099944 A1
(43) Pub. Date: Apr. 9, 2026

(54) ELECTRONIC DEVICE, METHOD, AND NON-TRANSITORY COMPUTER-READABLE STORAGE MEDIUM FOR USE OF CAMERA IN VEHICLE

(71) Applicant: THINKWARE CORPORATION, Seongnam-si (KR)

(72) Inventors: Yechan Choi, Seongnam-si (KR); Yosep Park, Seongnam-si (KR); Dongwon Shin, Seongnam-si (KR)

(73) Assignee: THINKWARE CORPORATION, Seongnam-si (KR)

(21) Appl. No.: 19/244,300

(22) Filed: Jun. 20, 2025

(30) Foreign Application Priority Data
Jun. 28, 2024 (KR) 10-2024-0085832

(51) Int. Cl. G06T 7/73

(52) U.S. Cl. CPC G06T 7/74; G06T 2207/30244; G06T 2207/30252

(57) ABSTRACT

An electronic device includes memory storing instructions, a camera, and at least one processor, and the instructions cause the electronic device to, while a relative distance between a first vehicle including the electronic device and a second vehicle different from the first vehicle is changed, obtain a plurality of images, obtain a plurality of first values indicating a size of the second vehicle, identify whether a range including second values is maintained until a threshold time elapses, wherein the second values are a portion of the plurality of the first values and are continually obtained, based on the range maintained until the threshold time elapses, determine, using position values of the second vehicle respectively related to the second values, a reference position of the second vehicle separated from the first vehicle by a reference distance, and determine, using the reference position, a direction in which the camera faces.

### TECHNICAL FIELD

The present disclosure relates to an electronic device, a method, and a non-transitory computer-readable storage medium for use of a camera in a vehicle.

### BACKGROUND ART

An electronic device and/or a service based on object recognition technology, including an algorithm for inferring an external object captured in an image, is being developed. For example, one or more external objects (e.g., a pedestrian, or a vehicle) may be recognized from the image, based on the object recognition technology. Information on the one or more recognized external objects may be used to automate and/or replace an action of a user according to an external object, such as automatic driving.

The above-described information may be provided as a related art for the purpose of helping understanding of the present disclosure.

No argument or decision is made as to whether any of the above description may be applied as a prior art related to the present disclosure.

### DISCLOSURE

### Technical Solution

An electronic device is provided. The electronic device may comprise memory, storing instructions, comprising one or more storage media, a camera, and at least one processor comprising processing circuitry. The instructions, when executed by the at least one processor individually or collectively, may cause the electronic device to, while a relative distance between a first vehicle including the electronic device and a second vehicle different from the first vehicle is changed, obtain, using the camera, a plurality of images. The instructions, when executed by the at least one processor individually or collectively, may cause the electronic device to obtain, using the plurality of images obtained using the camera, a plurality of first values indicating a size of the second vehicle. The instructions, when executed by the at least one processor individually or collectively, may cause the electronic device to identify whether a range including second values is maintained until a threshold time elapses, wherein the second values are a portion of the plurality of the first values and are continually obtained while the plurality of the first values are obtained. The instructions, when executed by the at least one processor individually or collectively, may cause the electronic device to, based on the range maintained until the threshold time elapses, determine, using position values of the second vehicle respectively related to the second values, a reference position of the second vehicle separated from the first vehicle by a reference distance. The instructions, when executed by the at least one processor individually or collectively, may cause the electronic device to, based on the range maintained until the threshold time elapses, determine, using the reference position, a direction in which the camera faces.

A method is described. The method may be executed in an electronic device comprising a camera. The method may comprise, while a relative distance between a first vehicle including the electronic device and a second vehicle different from the first vehicle is changed, obtaining, using the camera, a plurality of images. The method may comprise obtaining, using the plurality of images obtained using the camera, a plurality of first values indicating a size of the second vehicle. The method may comprise identifying whether a range including second values is maintained until a threshold time elapses, wherein the second values are a portion of the plurality of the first values and are continually obtained while the plurality of the first values are obtained. The method may comprise, based on the range maintained until the threshold time elapses, determining, using position values of the second vehicle respectively related to the second values, a reference position of the second vehicle separated from the first vehicle by a reference distance. The method may comprise, based on the range maintained until the threshold time elapses, determining, using the reference position, a direction in which the camera faces.

A non-transitory computer-readable storage medium is described. The non-transitory computer-readable storage medium may store one or more programs. The one or more programs, when executed by an electronic device having a camera, may comprise instructions that cause the electronic device to, while a relative distance between a first vehicle including the electronic device and a second vehicle different from the first vehicle is changed, obtain, using the camera, a plurality of images. The one or more programs, when executed by the electronic device, may comprise instructions that cause the electronic device to obtain, using the plurality of images obtained using the camera, a plurality of first values indicating a size of the second vehicle. The one or more programs, when executed by the electronic device, may comprise instructions that cause the electronic device to identify whether a range including second values is maintained until a threshold time elapses, wherein the second values are a portion of the plurality of the first values and are continually obtained while the plurality of the first values are obtained. The one or more programs, when executed by the electronic device, may comprise instructions that cause the electronic device to, based on the range maintained until the threshold time elapses, determine, using position values of the second vehicle respectively related to the second values, a reference position of the second vehicle separated from the first vehicle by a reference distance. The one or more programs, when executed by the electronic device, may comprise instructions that cause the electronic device to, based on the range maintained until the threshold time elapses, determine, using the reference position, a direction in which the camera faces.

An electronic device is provided. The electronic device may comprise memory, storing instructions, comprising one or more storage media, a camera, and at least one processor comprising processing circuitry. The instructions, when executed by the at least one processor individually or collectively, may cause the electronic device to, while a relative distance between a first vehicle including the electronic device and a second vehicle different from the first vehicle, obtain, using the camera, a plurality of images. The instructions, when executed by the at least one processor individually or collectively, may cause the electronic device to obtain, using the plurality of images obtained using the camera, a plurality of first values indicating a size of the second vehicle. The instructions, when executed by the at least one processor individually or collectively, may cause the electronic device to identify whether a range including second values is maintained until a threshold time elapses, wherein the second values are a portion of the plurality of the first values and are continually obtained while the plurality of the first values are obtained. The instructions, when executed by the at least one processor individually or collectively, may cause the electronic device to, based on identifying that the range is maintained until the threshold time elapses, determine a direction in which the camera faces using a reference position obtained using the range. The instructions, when executed by the at least one processor individually or collectively, may cause the electronic device to, based on identifying that the range is maintained until the threshold time elapses, provide information to change a posture of the camera in accordance with the determined direction. The instructions, when executed by the at least one processor individually or collectively, may cause the electronic device to, based on identifying that the range is extended in accordance with obtaining a value higher than all the second values or lower than all the second values as a value from among the plurality of first values before the threshold time elapses, delay determining the direction in which the camera faces.

A method is described. The method may be executed in an electronic device comprising a camera. The method may comprise, while a relative distance between a first vehicle including the electronic device and a second vehicle different from the first vehicle, obtaining, using the camera, a plurality of images. The method may comprise obtaining, using the plurality of images obtained using the camera, a plurality of first values indicating a size of the second vehicle. The method may comprise identifying whether a range including second values is maintained until a threshold time elapses, wherein the second values are a portion of the plurality of the first values and are continually obtained while the plurality of the first values are obtained. The method may comprise, based on identifying that the range is maintained until the threshold time elapses, determining a direction in which the camera faces using a reference position obtained using the range. The method may comprise, based on identifying that the range is maintained until the threshold time elapses, providing information to change a posture of the camera in accordance with the determined direction. The method may comprise, based on identifying that the range is extended in accordance with obtaining a value higher than all the second values or lower than all the second values as a value from among the plurality of first values before the threshold time elapses, delaying to determine the direction in which the camera faces.

A non-transitory computer-readable storage medium is described. The non-transitory computer-readable storage medium may store one or more programs. The one or more programs, when executed by an electronic device having a camera, may comprise instructions that cause the electronic device to, while a relative distance between a first vehicle including the electronic device and a second vehicle different from the first vehicle, obtain, using the camera, a plurality of images. The one or more programs, when executed by the electronic device, may comprise instructions that cause the electronic device to obtain, using the plurality of images obtained using the camera, a plurality of first values indicating a size of the second vehicle. The one or more programs, when executed by the electronic device, may comprise instructions that cause the electronic device to identify whether a range including second values is maintained until a threshold time elapses, wherein the second values are a portion of the plurality of the first values and are continually obtained while the plurality of the first values are obtained. The one or more programs, when executed by the electronic device, may comprise instructions that cause the electronic device to, based on identifying that the range is maintained until the threshold time elapses, determine a direction in which the camera faces using a reference position obtained using the range. The one or more programs, when executed by the electronic device, may comprise instructions that cause the electronic device to, based on identifying that the range is maintained until the threshold time elapses, provide information to change a posture of the camera in accordance with the determined direction. The one or more programs, when executed by the electronic device, may comprise instructions that cause the electronic device to, based on identifying that the range is extended in accordance with obtaining a value higher than all the second values or lower than all the second values as a value from among the plurality of first values before the threshold time elapses, delay determining the direction in which the camera faces.

### DESCRIPTION OF THE DRAWINGS

FIG. 1 illustrates an example of obtaining information on an external vehicle using an image.

FIG. 2 is a simplified block diagram of an exemplary electronic device.

FIG. 3 is a flowchart illustrating a method of determining a direction in which a camera faces using an image.

FIG. 4 illustrates an example of a change in an image in accordance with a change in a distance between vehicles.

FIG. 5 illustrates a chart that represents a change in a value indicating a size of an external vehicle.

FIG. 6 illustrates an exemplary method of determining a reference position using images.

FIG. 7 illustrates an exemplary method of determining a reference position by canceling a noise component with respect to position values of an external vehicle.

FIG. 8 illustrates an exemplary method of determining reference positions of a plurality of external vehicles.

FIG. 9 illustrates a chart indicating a size of an external vehicle under a condition in which a range of a value indicating the size of the external vehicle is extended.

FIG. 10 illustrates an exemplary method of determining a reference position in a case that a range of a value indicating a size of an external vehicle is extended.

FIG. 11 illustrates an exemplary method of determining a representative reference position using a plurality of reference positions.

FIG. 12 illustrates an exemplary method of identifying a reference line using a plurality of reference positions.

FIG. 13 illustrates an exemplary method of determining a representative reference position and identifying a reference line by canceling a noise component with respect to a plurality of reference positions.

FIG. 14 illustrates an exemplary method of providing information to change a posture of a camera.

FIG. 15 illustrates an example of a block diagram illustrating an autonomous driving system of a vehicle according to an embodiment.

FIGS. 16 and 17 illustrate an example of a block diagram indicating an autonomous driving moving object according to an embodiment.

FIG. 18 illustrates an example of a gateway related to a user device according to various embodiments.

FIG. 19 is a diagram for explaining an operation of an electronic device that trains a neural network based on a set of training data according to an embodiment.

FIG. 20 is a block diagram of an electronic device according to an embodiment.

### MODE FOR INVENTION

An electronic device (or an external electronic device) according to various embodiments disclosed in the present document may be one of various types of electronic devices. The electronic devices may include, for example, a computer device, a portable multimedia device, a camera (e.g., dash cam), a wearable device, a server, or a home appliance. According to an embodiment of the present document, the electronic device (or the external electronic device) is not limited to those described above.

It should be appreciated that various embodiments of the present document and the terms used therein are not intended to limit the technological features described in the present document to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. In the present document, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. Such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., by wire), wirelessly, or via a third element.

Various embodiments of the present document may be implemented as software (e.g., the program) including one or more instructions that are stored in a storage medium that is readable by a machine (e.g., the electronic device 110). For example, a processor of the machine (e.g., the electronic device 110) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

For example, a method according to various embodiments disclosed in the present document may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

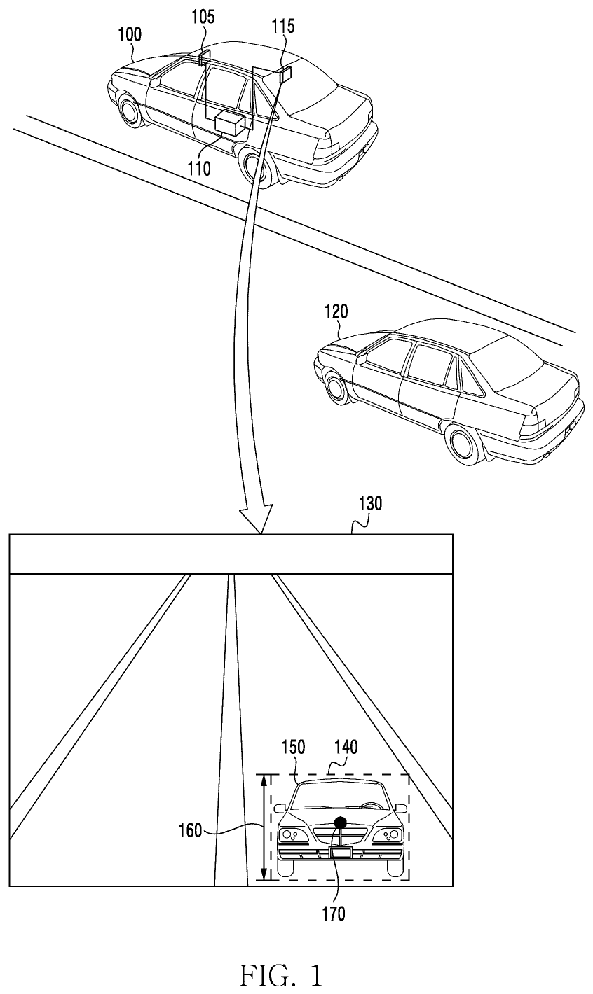

FIG. 1 illustrates an example of obtaining information on an external vehicle using an image.

Referring to FIG. 1, an example of an electronic device 110 included in a first vehicle 100 is illustrated. The electronic device 110 may correspond to an electronic control unit (ECU) in the first vehicle 100 or may be included in the ECU. The ECU may be referred to as an electronic control module (ECM). An embodiment is not limited thereto, and the electronic device 110 may correspond to a device (e.g., a dash cam) attached to the first vehicle 100 or may be included in the device.

For example, the electronic device 110 may be electrically and/or operatively connected to a camera 115 positioned toward a direction of the first vehicle 100. For example, the electronic device 110 electrically and/or operatively connected to the camera 115 may indicate the electronic device 110 electrically and/or operatively connected to a device including the camera 115. For example, the electronic device 110 electrically and/or operatively connected to the camera 115 may indicate the electronic device 110 including the camera 115.

FIG. 1 illustrates the camera 115 positioned toward a rear direction of the first vehicle 100, but this is only an example. For example, a direction of the camera 115 may be different from the direction illustrated in FIG. 1. As a non-limiting example, the camera 115 may be positioned toward a front direction of the first vehicle 100.

For example, the electronic device 110 may recognize an external object (e.g., a second vehicle 120) included in a field of view (FoV) of the camera 115 using an image 130 obtained through the camera 115. The operation of recognizing the external object may include an operation of identifying a type, a class, and/or a category of the external object. For example, the operation of recognizing the external object may include an operation of identifying a category corresponding to the external object captured by the image 130, from among designated categories such as a vehicle, a road, a sign, and/or a pedestrian. For example, the operation of recognizing the external object may include an operation of calculating a position (e.g., a two-dimensional coordinate value) of the external object with respect to the camera 115 and/or the first vehicle 100.

The following descriptions may relate to the electronic device 110, a method of the electronic device 110, a computer program executed by the electronic device 110, and/or a computer-readable storage medium including the computer program, which identify or calculate a position of the external object such as the second vehicle 120.

For example, the electronic device 110 may identify, from the image 130, a visual object 150 corresponding to the external object (e.g., the second vehicle 120) (or representing the external object). The electronic device 110 may determine a bounding box 140 including a periphery of the visual object 150 (or formed based on the periphery of the visual object) by recognizing the external object using the image 130. For example, the bounding box 140 may be defined or determined to identify a distance between the external object and the electronic device 110 (or the first vehicle 100). For example, the bounding box 140 may be defined or determined to identify a value indicating a size of the external object. For example, a height value 160 of the bounding box 140 may indicate the size of the external object.

For example, in a case that the rear camera 115 is directly mounted by a user, unlike a front camera, there may be a high probability that an initial position is abnormally mounted. For example, the rear camera 115 mounted on the first vehicle 100 directly by the user may be inclined with respect to the ground. For example, a distance between the first vehicle 100 and the external object, identified using the image 130 obtained by the rear camera 115 that is inclined with respect to the ground, may have an error. For example, such an error may reduce a quality of a service (e.g., path planning) for autonomous driving of the first vehicle 100. For example, the electronic device 110 may provide a function of adjusting a direction (or a posture) of the rear camera 115 inclined with respect to the ground to enhance the quality of the service for the autonomous driving of the first vehicle 100. For example, the electronic device 110 may determine a direction in which the camera 115 faces to provide the function.

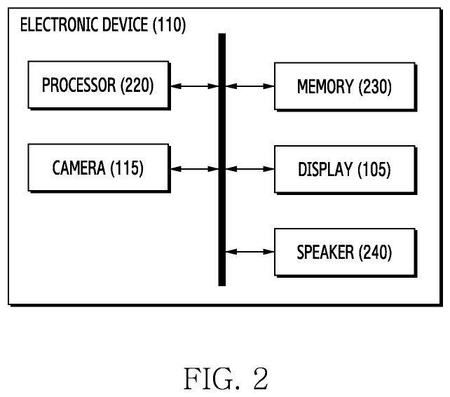

For example, the electronic device 110 may include a display 105. For example, the display 105 may be connected to the electronic device 110. For example, the electronic device 110 may determine the direction in which the camera 115 faces and display guidance to change a posture of the camera 115, through the display 105 of the electronic device 110 or the display 105 connected to the electronic device 110. The electronic device 110 is illustrated in a description of FIG. 2.

FIG. 2 is a simplified block diagram of an exemplary electronic device.

Referring to FIG. 2, an electronic device 110 may include a processor 220 and memory 230. For example, the electronic device 110 may further include a camera 115. For example, the electronic device 110 may further include a display 105 or a speaker 240. Some of hardware in FIG. 2 may be implemented as a single integrated circuit, such as a system on a chip (SoC). A type and/or the number of hardware included in the electronic device 110 is not limited as illustrated in FIG. 2. For example, the electronic device 110 may include only some of the hardware illustrated in FIG. 2.

For example, the electronic device 110 may include hardware for processing data based on one or more instructions. The hardware for processing data may include the processor 220. For example, the hardware for processing data may include a central processing unit (CPU) (e.g., including processing circuitry) and/or a graphic processing unit (GPU) (e.g., including processing circuitry). The processor 220 may have a single core, or have a structure of a multi-core processor including a plurality of core circuits, such as a multi-core, such as a dual core, a quad core, a hexa core, or an octa core. A function and/or an operation described with reference to the present disclosure may be performed individually and/or collectively by one or more processing circuitry included in the processor 220.

For example, the memory 230 of the electronic device 110 may include a hardware component for storing data and/or instructions that are inputted to or outputted from the processor 220 of the electronic device 110. For example, the memory 230 may include volatile memory such as random-access memory (RAM) and/or non-volatile memory such as read-only memory (ROM). The non-volatile memory may be referred to as storage. For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD), and an embedded multi-media card (eMMC). The memory 230 may include one or more storage media (e.g., the above-described volatile memory and/or non-volatile memory) positioned in the electronic device 110 in a distributed manner.

For example, the speaker 240 of the electronic device 110 may output an audio signal. The speaker 240 may receive an electrical signal. The speaker 240 may include an element for obtaining the electrical signal. The speaker 240 may convert the electrical signal into a sound wave signal. The speaker 240 may include an element for converting the electrical signal into the sound wave signal. The speaker 240 may output the audio signal including the converted sound wave signal. The speaker 240 may include an element for outputting the audio signal. The speaker 240 may include at least one voice coil that provides vibration to a diaphragm in the speaker 240 and a magnet capable of forming a magnetic field. When a current flows through the at least one voice coil, a magnetic field formed by the voice coil may vibrate the voice coil by interacting with the magnetic field formed by the magnet. The diaphragm connected to the voice coil may vibrate based on the vibration of the voice coil. The speaker 240 may output the audio signal based on the diaphragm.

The display 105 of the electronic device 110 according to an embodiment may output visualized information. For example, the display 105 may output the visualized information to a user under a control of the processor 220 including circuitry such as the graphic processing unit (GPU). The display 105 may include a flat panel display (FPD) or electronic paper. The FPD may include a liquid crystal display (LCD), a plasma display panel (PDP), and/or one or more light emitting diodes (LEDs). The LED may include an organic LED (OLED).

The camera 115 of the electronic device 110 according to an embodiment may include one or more lenses and an image sensor. For example, the one or more lenses may be implemented as a lens assembly. The lens assembly may include a wide-angle lens or a telephoto lens. The one or more lenses may collect light around the camera 115 (or around the electronic device 110) to obtain an image.

For example, the image sensor in the camera 115 may convert the light collected using the one or more lenses to an electrical signal to obtain the image. The image sensor may include, for example, one image sensor selected from image sensors with different attributes, such as a red, green, blue (RGB) sensor, a black and white (BW) sensor, an infrared (IR) sensor, or an ultra violet (UV) sensor, a plurality of image sensors with the same attributes, or a plurality of image sensors with different attributes. Each image sensor included in the image sensor may be, for example, implemented using a charged coupled device (CCD) sensor or a complementary metal oxide semiconductor (CMOS) sensor.

For example, the processor 220 of the electronic device 110 may obtain an image 130 using the camera 115. For example, the processor 220 may perform object recognition on the image 130. Based on the object recognition, the processor 220 may identify a portion related to an external object in the image 130. For example, the processor 220 may obtain a two-dimensional coordinate value indicating a center point 170 of a bounding box 140 based on a two-dimensional coordinate system of the image 130. For example, the processor 220 may obtain a value 160 indicating a size of the bounding box 140 based on the two-dimensional coordinate system of the image 130.

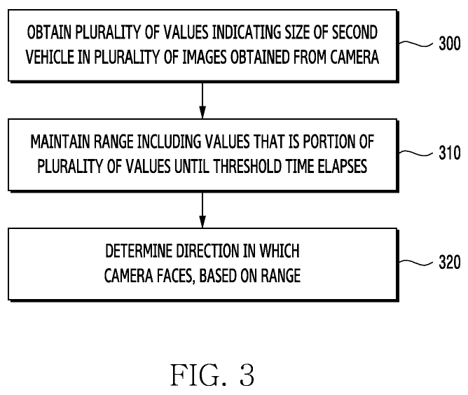

An operation of the electronic device 110 and/or the processor 220 for determining a direction in which the camera 115 faces using the image obtained through the camera 115 is illustrated in a description of FIG. 3.

FIG. 3 is a flowchart illustrating a method of determining a direction in which a camera faces using an image.

Referring to FIG. 3, in operation 300, at least one processor 220 may obtain a plurality of values indicating a size of a second vehicle in images including the second vehicle, which is a portion of a plurality of images obtained through a camera 115.

For example, the plurality of values indicating the size of the second vehicle may be height values of a bounding box of the image corresponding to the second vehicle. For example, the bounding box may be defined or determined to identify a value indicating the size of the second vehicle.

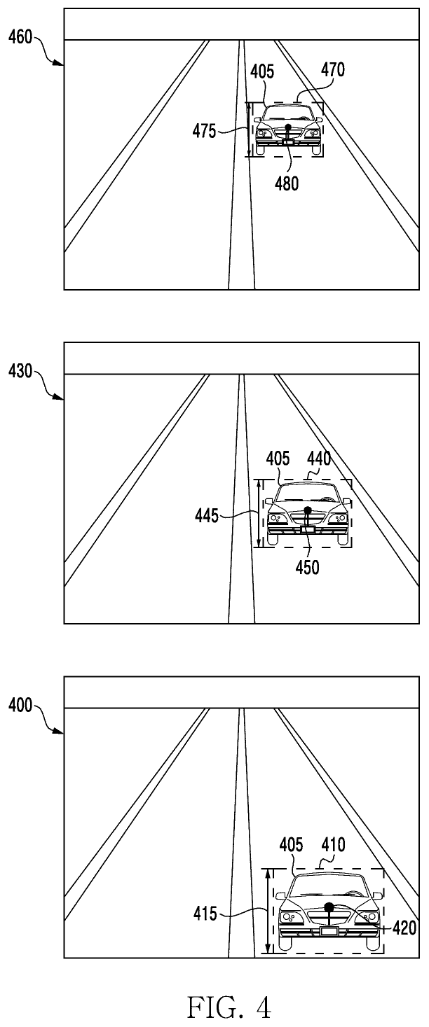

For example, the images including the second vehicle, which is the portion of the plurality of images, may be sequentially generated as time elapses. For example, the images including the second vehicle, which is the portion of the plurality of images, may include a visual object corresponding to the second vehicle. For example, the images including the second vehicle, which is the portion of the plurality of images, may be generated while a relative distance between a first vehicle and a second vehicle different from the first vehicle is changed. For example, since the images including the second vehicle, which is the portion of the plurality of images, are generated while the relative distance between the first vehicle and the second vehicle different from the first vehicle is changed, a size of a visual object included in each of the images including the second vehicle, which is the portion of the plurality of images, may be changed as time elapses. The images including the second vehicle, which is the portion of the plurality of images obtained through the camera 115 of the electronic device 110, are illustrated in a description of FIG. 4.

FIG. 4 illustrates an example of a change in an image in accordance with a change in a distance between vehicles.

Referring to FIG. 4, at least one processor 220 may obtain a first image 400, a second image 430, and a third image 460 that are a portion of a plurality of images through a camera 115. For example, the first image 400, the second image 430, and the third image 460 may be obtained while a relative distance between a first vehicle and a second vehicle is changed. For example, in a case that the camera 115 is installed behind the first vehicle, if speed of the first vehicle is faster than that of the second vehicle, the at least one processor 220 may sequentially obtain the first image 400, the second image 430, and the third image 460 through the camera 115. For example, in a case that the camera 115 is installed behind the first vehicle, if the speed of the first vehicle is slower than that of the second vehicle, the at least one processor 220 may sequentially obtain the third image 460, the second image 430, and the first image 400 through the camera 115.

For example, since the first image 400, the second image 430, and the third image 460 are obtained while the relative distance between the first vehicle and the second vehicle is changed, a visual object corresponding to the second vehicle may have different sizes within each of the first image 400, the second image 430, and the third image 460.

For example, the first image 400 may be obtained in a state in which the relative distance between the first vehicle and the second vehicle is a first distance, the second image 430 may be obtained in a state in which the relative distance between the first vehicle and the second vehicle is a second distance longer than the first distance, and the third image 460 may be obtained in a state in which the relative distance between the first vehicle and the second vehicle is a third distance longer than the second distance.

For example, a size of a visual object 405 (e.g., corresponding to the second vehicle) in the first image 400 obtained in a state in which the relative distance between the first vehicle and the second vehicle is the first distance may be larger than a size of the visual object 405 in the second image 430 obtained in a state in which the relative distance between the first vehicle and the second vehicle is the second distance. For example, the size of the visual object 405 in the second image 430 obtained in a state in which the relative distance between the first vehicle and the second vehicle is the second distance may be larger than a size of the visual object 405 in the third image 460 obtained in a state in which the relative distance between the first vehicle and the second vehicle is the third distance. For example, since the size of the visual object 405 in the first image 400 is larger than the size of the visual object 405 in the second image 430, a height of a bounding box 410 determined based on the visual object 405 in the first image 400 may be longer than a height of a bounding box 440 determined based on the visual object 405 in the second image 430. For example, since the size of the visual object 405 in the second image 430 is larger than the size of the visual object 405 in the third image 460, the height of the bounding box 440 determined based on the visual object 405 in the second image 430 may be longer than a height of the bounding box 470 determined based on the visual object 405 in the third image 460.

Referring back to FIG. 3, in operation 310, the at least one processor 220 may obtain a plurality of first values indicating a size of the second vehicle using images including the second vehicle, which is a portion of the plurality of images. For example, the at least one processor 220 may obtain second values that are continuously obtained while a plurality of first values are obtained and are a portion of the plurality of first values.

For example, the at least one processor 220 may identify whether a range including the second values is maintained until a threshold time elapses.

As a non-limiting example, the range including the second values may be a range between a minimum value and a maximum value of the second values. As a non-limiting example, the range including the second values being maintained until the threshold time elapses may be the minimum value and the maximum value of the second values being maintained.

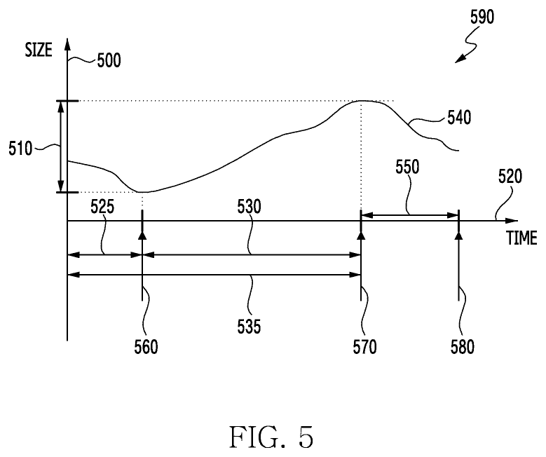

For example, the first values may vary in accordance with the relative distance between the first vehicle and the second vehicle. For example, the second values may vary in accordance with the relative distance between the first vehicle and the second vehicle. For example, the relative distance between the first vehicle and the second vehicle may be changed in accordance with time. The range including the second values being maintained until the threshold time elapses is illustrated in a description of FIG. 5.

FIG. 5 illustrates a chart that represents a change in a value indicating a size of an external vehicle.

Referring to FIG. 5, a chart 590 represents a change in a size of a second vehicle in accordance with time. A horizontal axis 520 in the chart 590 indicates the time, and a vertical axis 500 in the chart 590 indicates the size of the second vehicle.

For example, the size of the second vehicle may be represented as a line 540 in the chart 590.

For example, at least one processor 220 may obtain first values. The at least one processor 220 may obtain second values that are a portion of the first values. For example, the second values may be a portion of the first values that are continually obtained as time elapses.

For example, the first values may be a plurality of values representing a size of the second vehicle corresponding to a visual object in images (e.g., obtained through a camera 115).

For example, a value obtained at a time point 560 of the first values may be a minimum value among values (e.g., a portion of the first values) representing the size of the second vehicle obtained within a time interval 525 from the time point 560. For example, a value obtained at a time point 570 of the first values may be a maximum value among the values (e.g., the portion of the first values) representing the size of the second vehicle obtained within a time interval 535 from the time point 570. For example, the second values may be a portion of the first values obtained within a time interval 530 from the time point 560 to the time point 570.

For example, as indicated by the line 540, a range 510 (e.g., a range from the minimum value obtained at the time point 560 to the maximum value obtained at the time point 570) including the second values may be maintained until a threshold time 550 elapses. For example, the at least one processor 220 may identify that the range 510 including the second values is maintained until the threshold time 550 elapses. For example, the identification may start from the time point 570. For example, the identification may end at a time point 580.

For example, the threshold time 550 may be a predetermined time. For example, even if the second values increase and/or decrease during the threshold time 550, if the range 510 including the second values is maintained, the at least one processor 220 may continue to measure whether the threshold time 550 elapses.

Referring back to FIG. 3, in operation 310, the at least one processor 220 may identify whether the range including the second values is maintained until the threshold time elapses while the first values are obtained.

In operation 320, the at least one processor 220 may determine a direction in which the camera 115 faces, based on the range including the second values that is maintained until the threshold time elapses.

For example, the at least one processor 220 may determine the direction in which the camera 115 faces using position values of the second vehicle respectively related to the second values, based on the range including the second values maintained until the threshold time elapses.

In the example of FIG. 4, the at least one processor 220 may obtain a first position value 420 of the second vehicle in a first image 400 obtained through the camera 115. For example, the first position value 420 may be a center point of a bounding box 410. For example, the at least one processor 220 may obtain a second position value 450 of the second vehicle in a second image 430 obtained through the camera 115. For example, the second position value 450 may be a center point of a bounding box 440. For example, the at least one processor 220 may obtain a third position value 480 of the second vehicle in a third image 460 obtained through the camera 115. For example, the third position value 480 may be a center point of a bounding box 470.

In operation 320, the position values of the second vehicle respectively related to the second values may indicate position values of the second vehicle when sizes of bounding boxes with respect to images of the second vehicle are the second values.

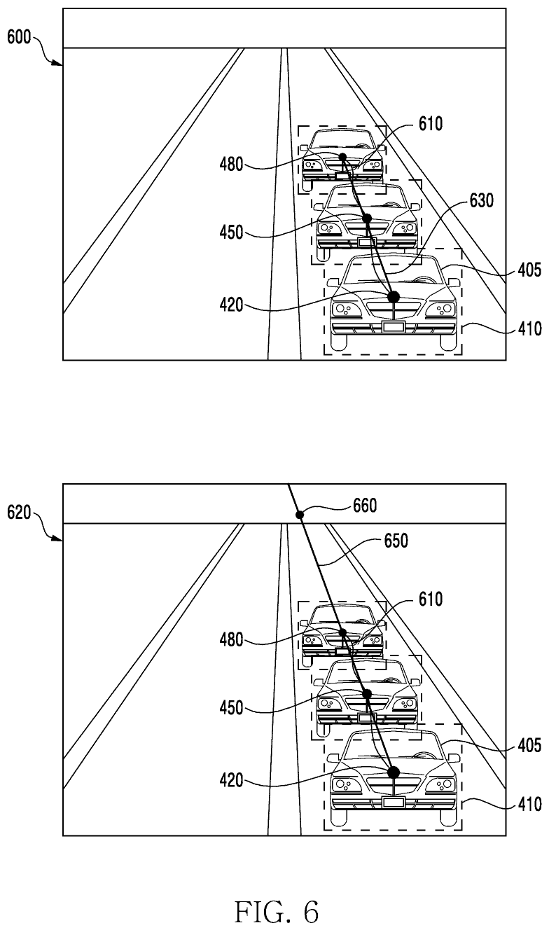

For example, the at least one processor 220 may use the position values of the second vehicle to determine a reference position of the second vehicle separated from a first vehicle by a reference distance. For example, the reference position of the second vehicle may be determined to determine a position of a vanishing point of a visual object (e.g., corresponding to the second vehicle) within each of the images obtained through the camera 115 or a position close to the vanishing point of the visual object. Determining the reference position of the second vehicle using the position values of the second vehicle is illustrated in a description of FIG. 6.

FIG. 6 illustrates an exemplary method of determining a reference position using images.

Referring to FIG. 6, at least one processor 220 may determine a reference position 660 of a second vehicle separated from a first vehicle by a reference distance using a first position value 420 of the second vehicle, a second position value 450 of the second vehicle, and a third position value 480 of the second vehicle.

For example, the at least one processor 220 may identify or obtain the first position value 420 of the second vehicle in a first image 400, the second position value 450 of the second vehicle in a second image 430, and the third position value 480 of the second vehicle in a third image 460, which are respectively related to second values in a range including the second values maintained during a threshold time.

For example, there may be at least one image between the first image 400 and the second image 430. For example, at least one position value of the second vehicle may be identified or obtained using at least one image obtained through a camera 115 within a time interval between a time of obtaining an image (e.g., one of a plurality of images obtained through the camera 115) used to identify the first position value 420 of the second vehicle and a time of obtaining an image (e.g., one of the plurality of images obtained through the camera 115) used to identify the second position value 450 of the second vehicle.

For example, there may be at least one image between the second image 430 and the third image 460. For example, at least one position value of the second vehicle may be identified or obtained using at least one image obtained through the camera 115 within a time interval between the time of obtaining the image (e.g., one of the plurality of images obtained through the camera 115) used to identify the second position value 450 of the second vehicle and a time of obtaining an image (e.g., one of the plurality of images obtained through the camera 115) used to identify the third position value 480 of the second vehicle.

For example, the at least one processor 220 may obtain a curve 610 connecting the first position value 420 of the second vehicle, at least one position value of the second vehicle between the first position value 420 of the second vehicle and the second position value 450, the second position value 450 of the second vehicle, at least one position value of the second vehicle between the second position value 450 of the second vehicle and the third position value 480 of the second vehicle, and the third position value 490 of the second vehicle. As a non-limiting example, since the curve 610 does not have a pattern, it may be substantially impossible to determine the reference position 660 of the second vehicle using the curve 610.

For example, the first position value 420 of the second vehicle may be a position value of the second vehicle related to a maximum value among the second values in a range maintained during the threshold time. For example, the third position value 480 of the second vehicle may be a position value of the second vehicle related to a minimum value among the second values in the range maintained during the threshold time.

For example, the at least one processor 220 may obtain a first straight line 630 using the first position value 420 of the second vehicle and the third position value 480 of the second vehicle. For example, the first straight line 630 may be obtained by applying the first position value 420 of the second vehicle and the third position value 480 of the second vehicle to Equation 1 below.

$$y = \frac{{y}_{max} - {y}_{min}}{{x}_{max} - {x}_{min}} * ( x - {x}_{max} ) + {y}_{max} \qquad [ Equation 1 ]$$

In Equation 1, the y may indicate a y-coordinate in the image obtained through the camera 115, the ymax may indicate a y-coordinate of the position value of the second vehicle related to the maximum value among the second values in the range maintained during the threshold time, the ymin may indicate a y-coordinate of the position value of the second vehicle related to the minimum value among the second values in the range maintained during the threshold time, the xmax may indicate an x-coordinate of the position value of the second vehicle related to the maximum value among the second values in the range maintained during the threshold time, and the xmin may indicate an x-coordinate of the position value of the second vehicle related to the minimum value among the second values in the range maintained during the threshold time.

For example, an equation (e.g., an equation indicating a relationship between the x and the y) obtained by applying the first position value 420 of the second vehicle and the third position value 480 of the second vehicle to Equation 1 may indicate the first straight line 630.

For example, the reference position 660 of the second vehicle may be determined by applying the first position value 420 of the second vehicle, the second position value 450 of the second vehicle, and the third position value 480 of the second vehicle to Equation 2.

$$y = \overline{y} - \frac{\sum ( x - \overline{x} ) ( y - \overline{y} )}{\sum {( x - \overline{x} )}^{2}} \overline{x} + \frac{\sum ( x - \overline{x} ) ( y - \overline{y} )}{\sum {( x - \overline{x} )}^{2}} \cdot x \qquad [ Equation 2 ]$$

In Equation 2, the y may indicate the y-coordinate in the image obtained through the camera 115, the y may indicate an average value of y-coordinates of position values of the second vehicle related to the second values in the range maintained during the threshold time, the x may indicate the x-coordinate in the image obtained through the camera 115, and the x may indicate an average value of x-coordinates of the position values of the second vehicle related to the second values in the range maintained during the threshold time.

For example, an equation (e.g., an equation indicating a relationship between the x and the y) obtained by applying the first position value 420 of the second vehicle, the second position value 450 of the second vehicle, and the third position value 480 of the second vehicle to Equation 2 may indicate a second straight line.

For example, in a state 620 in which the at least one processor 220 determines the reference position 660 of the second vehicle, the at least one processor 220 may extend the first straight line 630 or the second straight line to a portion outside the range maintained during the threshold time.

For example, the at least one processor 220 may determine the reference position 660 of the second vehicle using a straight line 650 extending from the first straight line 630 or a straight line extending from the second straight line. For example, the reference position 660 of the second vehicle may be a position value of the second vehicle when a value indicating the size of the second vehicle is a reference value. For example, the reference value may be a predetermined value. As a non-limiting example, the reference value may be 0.

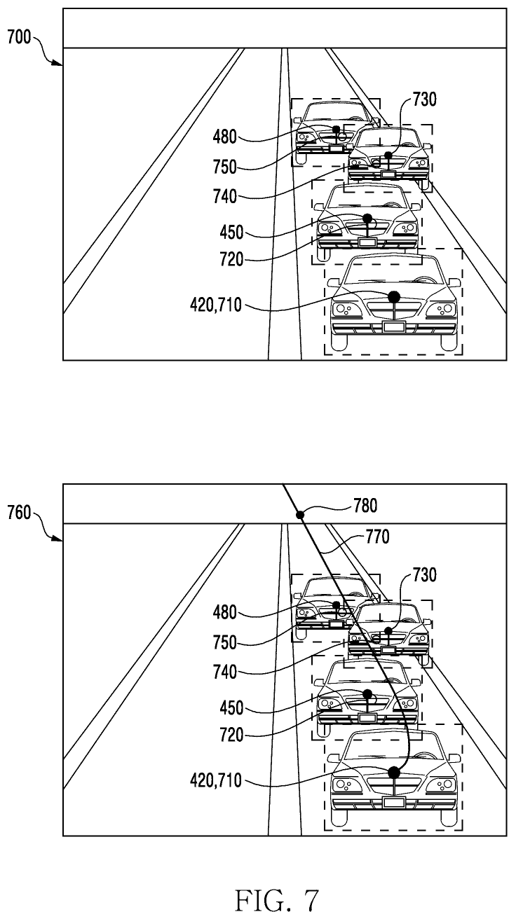

For example, if the position values of the second vehicle including the first position value 420 of the second vehicle, the second position value 450 of the second vehicle, and the third position value 480 of the second vehicle, include a noise component, the reference position 660 of the second vehicle determined using the position values of the second vehicle may not be close to a vanishing point of a visual object corresponding to the second vehicle in each of the images obtained through the camera 115. For example, canceling the noise component in each of the position values of the second vehicle may be used to determine the reference position 660 of the second vehicle. The cancelling the noise component of the position values of the second vehicle is illustrated in a description of FIG. 7.

FIG. 7 illustrates an exemplary method of determining a reference position by canceling a noise component with respect to position values of an external vehicle.

Referring to FIG. 7, at least one processor 220 may obtain position values of a second vehicle in which a noise component is included. For example, in a state 700 in which a range including second values is maintained during a threshold time, the at least one processor 220 may obtain a first position value 420 of the second vehicle, a second position value 450 of the second vehicle, a fourth position value 730 of the second vehicle, and a third position value 480 of the second vehicle. For example, the first position value 420 of the second vehicle, the second position value 450 of the second vehicle, the fourth position value 730 of the second vehicle, and/or the third position value 480 of the second vehicle may include the noise component.

For example, the at least one processor 220 may adjust, based on obtaining a position value of the second vehicle from among the first position value 420 of the second vehicle, the second position value 450 of the second vehicle, the fourth position value 730 of the second vehicle, and the third position value 480 of the second vehicle, the obtained position value of the second vehicle using a weighted sum of at least one position value of the second vehicle from among position values of the second vehicle obtained before the obtained position value of the second vehicle.

For example, position values of the second vehicle in which the noise component is canceled may be obtained by applying the position values of the second vehicle including the noise component to Equation 3 below.

$$\overline{{x}_{k}} = α \overline{{x}_{k - 1}} + ( 1 - α ) {x}_{k} \qquad [ Equation 3 ]$$

$$\overline{{y}_{k}} = α \overline{{y}_{k - 1}} + ( 1 - α ) {y}_{k}$$

$$0 < α < 1$$

In Equation 3, the xₖ may indicate an x-coordinate of a position value of the second vehicle in an image of a k-th frame, the x̅ₖ̅ may indicate an x-coordinate of an adjusted position value of the second vehicle in the image of the k-th frame, the x̅ₖ̅₋̅₁̅ may indicate an x-coordinate of an adjusted position value of the second vehicle in an image of a (k−1)-th frame, the yₖ may indicate a y-coordinate of the position value of the second vehicle in the image of the k-th frame, the y̅ₖ̅ may indicate a y-coordinate of the adjusted position value of the second vehicle in the image of the k-th frame, the y̅ₖ̅₋̅₁̅ may indicate a y-coordinate of the adjusted position value of the second vehicle in the image of the (k−1)-th frame, and the a may indicate a weight value.

For example, values obtained by applying the position values of the second vehicle including the noise component to Equation 3 may indicate the position values of the second vehicle in which the noise component is canceled.

For example, in the state 700, in a case that the first position value 420 of the second vehicle is the earliest obtained position value of the second vehicle, the first position value 420 of the second vehicle and an adjusted first position value 710 of the second vehicle may be the same.

For example, the first position value 420 of the second vehicle may be a position value of the second vehicle obtained before the second position value 450 of the second vehicle. For example, the at least one processor 220 may obtain an adjusted second position value 720 of the second vehicle by applying the first position value 420 of the second vehicle and the second position value 450 of the second vehicle to Equation 3. For example, in the adjusted second position value 720 of the second vehicle, a weight value (e.g., 1−α) of the second position value 450 of the second vehicle may be relatively greater than a weight value (e.g., α) of the first position value 420 of the second vehicle. For example, the adjusted second position value 720 of the second vehicle may be relatively closer to the second position value 450 of the second vehicle than the first position value 420 of the second vehicle.

For example, the fourth position value 730 of the second vehicle may be a position value of the second vehicle obtained after the second position value 450 of the second vehicle. For example, the at least one processor 220 may obtain an adjusted fourth position value 740 of the second vehicle by applying the first position value 420 of the second vehicle, the second position value 450 of the second vehicle, and the fourth position value 730 of the second vehicle to Equation 3. For example, in the adjusted fourth position value 740 of the second vehicle, a weight value (e.g., 1−α) of the fourth position value 730 of the second vehicle may be relatively greater than a weight value (e.g., α) of the first position value 420 of the second vehicle and the second position value 450 of the second vehicle. For example, the adjusted fourth position value 740 of the second vehicle may be relatively closer to the fourth position value 730 of the second vehicle than the first position value 420 of the second vehicle and the second position value 450 of the second vehicle.

For example, the third position value 480 of the second vehicle may be a position value of the second vehicle obtained after the fourth position value 730 of the second vehicle. For example, the at least one processor 220 may obtain an adjusted third position value 750 of the second vehicle by applying the first position value 420 of the second vehicle, the second position value 450 of the second vehicle, the fourth position value 730 of the second vehicle, and the third position value 480 of the second vehicle to Equation 3. For example, in the adjusted third position value 750 of the second vehicle, a weight value (e.g., 1−α) of the third position value 480 of the second vehicle may be relatively greater than a weight value (e.g., α) of the first position value 420 of the second vehicle, the second position value 450 of the second vehicle, and the fourth position value 730 of the second vehicle. For example, the adjusted third position value 750 of the second vehicle may be relatively closer to the third position value 480 of the second vehicle than the first position value 420 of the second vehicle, the second position value 450 of the second vehicle, and the fourth position value 730 of the second vehicle.

For example, the at least one processor 220 may determine a reference position of the second vehicle separated from a first vehicle by a reference distance by using the adjusted first position value 710 of the second vehicle, the adjusted second position value 720 of the second vehicle, the adjusted fourth position value 740 of the second vehicle, and the adjusted third position value 750 of the second vehicle, instead of the first position value 420, the second position value 450 of the second vehicle, the fourth position value 730 of the second vehicle, and the third position value 480 of the second vehicle.

For example, the at least one processor 220 may obtain a third straight line by applying the adjusted first position value 710 of the second vehicle and the adjusted third position value 750 of the second vehicle to Equation 1. For example, the at least one processor 220 may extend the third straight line to a portion outside the range maintained during the threshold time.

For example, the at least one processor 220 may determine a reference position of the second vehicle using the third straight line extending to the portion outside the range maintained during the threshold time.

For example, the at least one processor 220 may obtain a fourth straight line by applying the adjusted first position value 710 of the second vehicle, the adjusted second position value 720 of the second vehicle, the adjusted fourth position value 740 of the second vehicle, and the adjusted third position value 750 of the second vehicle to Equation 2. For example, the at least one processor 220 may extend the fourth straight line to the portion outside the range maintained during the threshold time.

For example, the at least one processor 220 may determine a reference position of the second vehicle using the fourth straight line extending to the portion outside the range maintained during the threshold time.

For example, the at least one processor 220 may obtain a fifth straight line by applying the unadjusted first position value 420 of the second vehicle and the unadjusted third position value 480 of the second vehicle to Equation 1. For example, the at least one processor 220 may extend the fifth straight line to the portion outside the range maintained during the threshold time.

For example, the at least one processor 220 may determine a reference position of the second vehicle using the fifth straight line extending to the portion outside the range maintained during the threshold time.

For example, the at least one processor 220 may obtain a sixth straight line by applying the unadjusted first position value 420 of the second vehicle, the unadjusted second position value 450 of the second vehicle, the unadjusted fourth position value 730 of the second vehicle, and the unadjusted third position value 480 of the second vehicle to Equation 2. For example, the at least one processor 220 may extend the sixth straight line to the portion outside the range maintained during the threshold time.

For example, the at least one processor 220 may determine a reference position of the second vehicle using the sixth straight line extending to the portion outside the range maintained during the threshold time.

For example, a reference position of the second vehicle determined using the third straight line or the fourth straight line may be relatively more robust to noise than a reference position of the second vehicle determined using the fifth straight line or the sixth straight line. For example, a reference position of the second vehicle determined using the third straight line may be relatively closer to a vanishing point of a visual object corresponding to the second vehicle in each of images obtained through a camera 115 than a reference position of the second vehicle determined using the fifth straight line. For example, the reference position of the second vehicle determined using the fourth straight line may be relatively closer to the vanishing point of the visual object corresponding to the second vehicle in each of the images obtained through the camera 115 than the reference position of the second vehicle determined using the sixth straight line.

For example, the at least one processor 220 may obtain a first curve 770 using the adjusted first position value 710 of the second vehicle, the adjusted second position value 720 of the second vehicle, the adjusted fourth position value 740 of the second vehicle, and the adjusted third position value 750 of the second vehicle. For example, the first curve 770 may be obtained by applying the adjusted first position value 710 of the second vehicle, the adjusted second position value 720 of the second vehicle, the adjusted fourth position value 740 of the second vehicle, and the adjusted third position value 750 of the second vehicle to Equation 4 below.

$$y = {b}_{0} + {b}_{1} \cdot x + {b}_{2} \cdot {x}^{2} \qquad [ Equation 4 ]$$

$$[ \begin{matrix}\sum {x}^{0} & \sum {x}^{1} & \sum {x}^{2} \\ \sum {x}^{1} & \sum {x}^{2} & \sum {x}^{3} \\ \sum {x}^{2} & \sum {x}^{3} & \sum {x}^{4}\end{matrix} ] [ \begin{matrix}{b}_{0} \\ {b}_{1} \\ {b}_{2}\end{matrix} ] = [ \begin{matrix}\sum {yx}^{0} \\ \sum {yx}^{1} \\ \sum {yx}^{2}\end{matrix} ]$$

In Equation 4, the y may indicate a y-coordinate in the image obtained through the camera 115, the x may indicate an x-coordinate in the image obtained through the camera 115, the b0 may indicate a constant, the b1 may indicate a coefficient of the x, and the b2 may indicate a coefficient of square of the x.

For example, an equation (e.g., an equation indicating a relationship between the x and the y) obtained by applying the adjusted first position value 710 of the second vehicle, the adjusted second position value 720, the adjusted fourth position value 740 of the second vehicle, and the adjusted third position value 750 of the second vehicle in Equation 4, may be represented as the first curve 770.

For example, the at least one processor 220 may extend the first curve 770 to the portion outside the range maintained during the threshold time.

For example, in a state 760 in which the at least one processor 220 has obtained the first curve 770, the at least one processor 220 may determine a reference position 780 of the second vehicle using the extended first curve 770. For example, the reference position 780 of the second vehicle may be a position value of the second vehicle when a value indicating a size of the second vehicle is a reference value. For example, the reference value may be a predetermined value. For example, the reference value may be 0.

For example, the at least one processor 220 may obtain a second curve by applying the first position value 420 of the second vehicle, the second position value 450 of the second vehicle, the fourth position value 730 of the second vehicle, and the third position value 480 of the second vehicle to Equation 4. For example, the at least one processor 220 may extend the second curve to the portion outside the range maintained during the threshold time.

For example, the at least one processor 220 may determine a reference position of the second vehicle using the second curve extending to the portion outside the range maintained during the threshold time.

For example, the reference position of the second vehicle determined using the first curve may be relatively more robust to noise than the reference position of the second vehicle determined using the second curve. For example, the reference position of the second vehicle determined using the first curve may be relatively closer to the vanishing point of the visual object corresponding to the second vehicle in each of the images obtained through the camera 115 than the reference position of the second vehicle determined using the second curve.

For example, there may be the adjusted fourth position value 740 of the second vehicle that is relatively separated from the third straight line. For example, in a case that there is the adjusted fourth position value 740 of the second vehicle that is relatively separated from the third straight line, the reference position of the second vehicle determined using the second straight line may be relatively close to the vanishing point of the visual object corresponding to the second vehicle in each of the images obtained through the camera 115 than the reference position of the second vehicle determined using the third straight line.

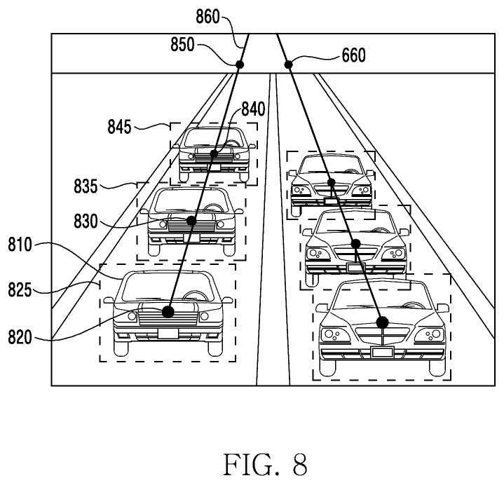

For example, in a case that there are a plurality of external vehicles in the image obtained through the camera 115, the at least one processor 220 may determine a plurality of reference positions for each of the plurality of external vehicles. Determining the plurality of reference positions for each of the external vehicles is illustrated in a description of FIG. 8.

FIG. 8 illustrates an exemplary method of determining reference positions of a plurality of external vehicles.

Referring to FIG. 8, at least one processor 220 may determine a reference position 850 of a third vehicle using position values of the third vehicle that are different from a first vehicle and different from a second vehicle.

For example, there may be an image 810 of the third vehicle in an image obtained through a camera 115. For example, the at least one processor 220 may obtain a plurality of values indicating a size of the third vehicle in images including the third vehicle, which are a portion of a plurality of images obtained through the camera 115. For example, the plurality of values indicating the size of the third vehicle may be height values of bounding boxes of an image corresponding to the third vehicle.

For example, the at least one processor 220 may obtain a plurality of third values indicating the size of the third vehicle. For example, the at least one processor 220 may obtain fourth values, which are a portion of the third values while obtaining the plurality of third values. For example, the fourth values may be a portion of the third values continually obtained as time elapses.

For example, the at least one processor 220 may identify whether a range including the fourth values is maintained until a threshold time elapses. For example, the at least one processor 220 may determine a direction in which the camera 115 faces using the position values of the third vehicle respectively related to the fourth values, based on identifying that the range including the fourth values is maintained until the threshold time elapses.

For example, the at least one processor 220 may obtain a first position value 820 of the third vehicle. For example, the first position value 820 of the third vehicle may be a center point of a bounding box 825. For example, the at least one processor 220 may obtain a second position value 830 of the third vehicle. For example, the second position value 830 of the third vehicle may be a center point of a bounding box 835. For example, the at least one processor 220 may obtain a third position value 840 of the third vehicle. For example, the third position value 840 of the third vehicle may be a center point of a bounding box 845.

For example, a position value of the third vehicle related to a maximum value among the fourth values in the range maintained during the threshold time may be the first position value 820 of the third vehicle. For example, a position value of the third vehicle related to a minimum value among the fourth values in the range is maintained during the threshold time may be the third position value 840 of the third vehicle.

For example, the position values of the third vehicle respectively related to the fourth values may include the first position value 820 of the third vehicle, the second position value 830 of the third vehicle, and the third position value 840 of the third vehicle. For example, the at least one processor 220 may determine the reference position 850 of the third vehicle separated by a reference distance from the first vehicle by using the first position value 820 of the third vehicle, the second position value 830 of the third vehicle, and the third position value 840 of the third vehicle.

As a non-limiting example, the at least one processor 220 may obtain a seventh straight line 860 by applying the first position value 820 of the third vehicle and the third position value 840 of the third vehicle to Equation 1. As a non-limiting example, the at least one processor 220 may obtain an eighth straight line by applying the first position value 820 of the third vehicle, the second position value 830 of the third vehicle, and the third position value 840 of the third vehicle to Equation 2. As a non-limiting example, the at least one processor 220 may obtain a third curve by applying the first position value 820 of the third vehicle, the second position value 830 of the third vehicle, and the third position value 840 of the third vehicle to Equation 4. As a non-limiting example, the at least one processor 220 may determine the reference position 850 of the third vehicle separated from the first vehicle by the reference distance using the seventh straight line 860, the eighth straight line, or the third curve. However, it is not limited thereto.

For example, the at least one processor 220 may determine the direction in which the camera 115 faces using a reference position 660 of the second vehicle and the reference position 850 of the third vehicle.

Referring back to FIG. 3, in operation 310, although not illustrated in FIG. 3, the range including the second values may be extended as the range obtains a value higher than all the second values or lower than all the second values before the threshold time elapses.

For example, based on identifying that the range is extended, the at least one processor 220 may identify whether the extended range including at least another portion of the first values is maintained until the threshold time elapses. For example, the at least one processor 220 may delay determining the direction in which the camera 115 faces based on identifying that the range is extended.

For example, in a case that the range is extended before the threshold time elapses, the at least one processor 220 may measure the threshold time again.

For example, the at least one processor 220 may obtain the value higher than all the second values or lower than all the second values after the range is maintained until the threshold time elapses.

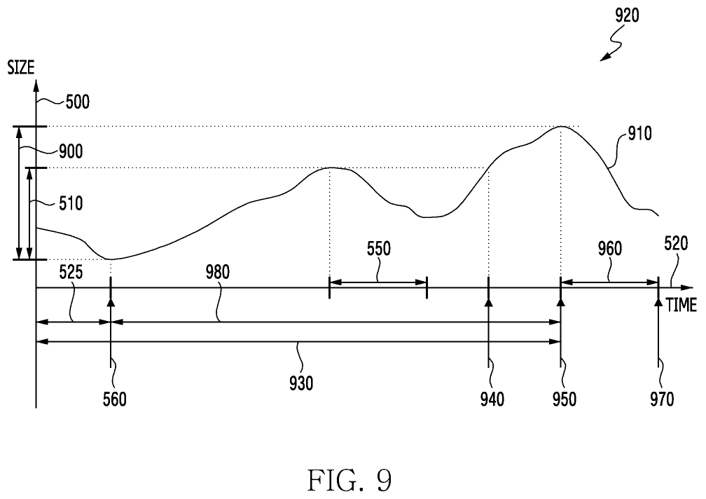

For example, after the at least one processor 220 determines a reference position of the second vehicle, the range may be extended in accordance with obtaining the value higher than all the second values or lower than all the second values as the second values of the range. For example, the at least one processor 220 may identify whether the extended range is maintained until the threshold time elapses. For example, the at least one processor 220 may determine another reference position of the second vehicle based on identifying whether the extended range is maintained until the threshold time elapses. The range being extended and the extended range being maintained during the threshold time are illustrated in a description of FIG. 9.

FIG. 9 illustrates a chart indicating a size of an external vehicle that is changed under a condition in which a range of a value indicating the size of the external vehicle is extended.

Referring to FIG. 9, a chart 920 indicates a change in a size of a second vehicle as time elapses. A horizontal axis 520 in the chart 920 indicates the time, and a vertical axis 500 in the chart 920 indicates the size of the second vehicle.

For example, the size of the second vehicle may be represented as a line 910 in the chart 920.

For example, at least one processor 220 may obtain a value in which a first range 510 is higher than all the second values or lower than all the second values after the first range 510 including the second values is maintained during a threshold time 550. For example, the first range 510 may be extended by obtaining a value higher than all the second values or lower than all the second values. For example, the value higher than all the second values or lower than all the second values may be included in another portion of the first values.

For example, at a time point 940, the at least one processor 220 may obtain a value higher than all the second values in the first range.

For example, the at least one processor 220 may obtain a portion of fifth values based on the extended first range after the first range is maintained until the threshold time 550 elapses. For example, the at least one processor 220 may obtain the fifth values that are a portion of the first values. For example, the fifth values may be a portion of the first values continually obtained as time elapses. For example, the fifth values may include the second values. For example, the fifth values may include the value higher than all the second values or lower than all the second values.

For example, a value obtained at a time point 560 of the first values may be a minimum value among values (e.g., a portion of the first values) indicating the size of the second vehicle obtained within a time interval 525 from the time point 560. For example, a value obtained at a time point 950 of the first values may be a maximum value among the values (e.g., the portion of the first values) indicating the size of the second vehicle obtained within a time interval 930 from the time point 950. For example, the fifth values may be a portion of the first values obtained within a time interval 980 from the time point 560 to the time point 950.

For example, as indicated by the line 910, the second range 900 (e.g., the range 900 from the minimum value obtained at the time point 560 to the maximum value obtained at the time point 950) may be maintained until a threshold time 960 elapses.

For example, the at least one processor 220 may identify that the second range 900 is maintained until the threshold time 960 elapses, based on identifying that the first range 510 is extended. For example, the identification of the second range 900 being maintained until the threshold time 960 elapses may start from the time point 950. For example, the identification of the second range 900 being maintained until the threshold time 960 elapses may end at a time point 970.

For example, the threshold time 960 may be a predetermined time. For example, even if the fifth values increase and/or decrease during the threshold time 960, if the second range 900 is maintained, the at least one processor 220 may continue to measure whether the threshold time 960 elapses.

Although not illustrated in FIG. 9, the second range 900 may be extended as the second range 900 obtains a value higher than all the fifth values or lower than all the fifth values before the threshold time 960 elapses.

For example, based on identifying that the second range 900 is extended, the at least one processor 220 may identify whether the extended second range including at least another portion of the first values is maintained until the threshold time elapses. For example, the at least one processor 220 may delay determining a direction in which the camera 115 faces based on identifying that the second range is extended.

For example, in a case that the second range 900 is extended before the threshold time 960 elapses, the at least one processor 220 may measure the threshold time 960 again.

For example, the at least one processor 220 may obtain the value higher than all the fifth values or lower than all the fifth values after the second range 900 is maintained until the threshold time 960 elapses.

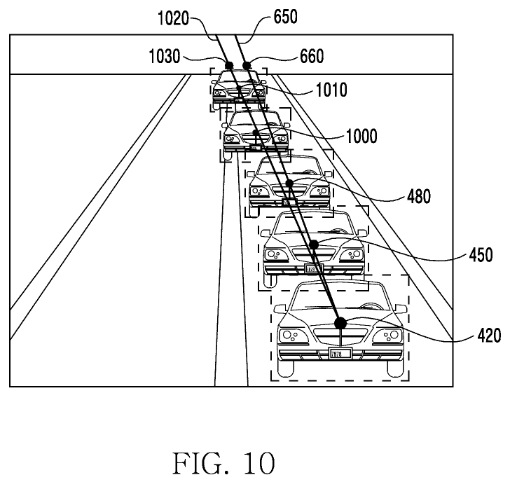

For example, the at least one processor 220 may determine a first reference position of the second vehicle using position values of the second vehicle respectively related to the second values in the first range 510, and determine a second reference position of the second vehicle using position values of the second vehicle respectively related to the fifth values in the second range 900. Determining a plurality of reference positions of the second vehicle is illustrated in a description of FIG. 10.

FIG. 10 illustrates an exemplary method of determining a reference position in a case that a range of a value indicating a size of an external vehicle is changed under an extended condition.

Referring to FIG. 10, at least one processor 220 may determine a first reference position 660 of a second vehicle and a second reference position 1030 of a second vehicle using position values of the second vehicle.

For example, a first position value 420 of the second vehicle may be a position value of the second vehicle related to a maximum value in a first range maintained during a threshold time. For example, a third position value 480 of the second vehicle may be a position value of the second vehicle related to a minimum value in the first range maintained during the threshold time.

For example, the position values of the second vehicle respectively related to the second values in the first range maintained during the threshold time may include the first position value 420 of the second vehicle, a second position value 450 of the second vehicle, and the third position value 480 of the second vehicle. For example, the at least one processor 220 may determine the first reference position 660 of the second vehicle separated from a first vehicle by a reference distance by using the first position value 420 of the second vehicle, the second position value 450 of the second vehicle, and the third position value 480 of the second vehicle.

As a non-limiting example, the at least one processor 220 may obtain a first straight line 630 by applying the first position value 420 of the second vehicle and the third position value 480 of the second vehicle to Equation 1. As a non-limiting example, the at least one processor 220 may obtain a second straight line by applying the first position value 420 of the second vehicle, the second position value 450 of the second vehicle, and the third position value 480 of the second vehicle to Equation 2. As a non-limiting example, the at least one processor 220 may obtain a second curve by applying the first position value 420 of the second vehicle, the second position value 450 of the second vehicle, and the third position value 480 of the second vehicle to Equation 4. As a non-limiting example, the at least one processor 220 may determine the first reference position 660 of the second vehicle spaced apart from the first vehicle by the reference distance using the first straight line 630, the second straight line, or the second curve. However, it is not limited thereto.

For example, the at least one processor 220 may identify that the first range is extended after the first range is maintained until the threshold time elapses. For example, the at least one processor 220 may identify whether a second range including the fifth values is maintained until the threshold time elapses based on the identification.

For example, the at least one processor 220 may obtain a fifth image and a sixth image through a camera 115. For example, the fifth image may be an image obtained after the first range is extended. For example, the sixth image may be an image obtained after the fifth image is obtained.

For example, the at least one processor 220 may obtain a fifth position value 1000 of the second vehicle in the fifth image. For example, the at least one processor 220 may obtain a sixth position value 1010 of the second vehicle in the sixth image.

For example, a position value of the second vehicle related to the fifth value obtained after the first range is extended may be the fifth position value 1000 of the second vehicle. For example, a position value of the second vehicle related to a minimum value in the second range maintained during the threshold time may be the sixth position value 1010 of the second vehicle.

For example, position values of the second vehicle respectively related to the fifth values may include the first position value 420 of the second vehicle, the second position value 450 of the second vehicle, the third position value 480 of the second vehicle, the fifth position value 1000 of the second vehicle, and the sixth position value 1010 of the second vehicle. For example, the at least one processor 220 may determine the second reference position 1030 of the second vehicle separated from the first vehicle by the reference distance by using the first position value 420 of the second vehicle, the second position value 450 of the second vehicle, the third position value 480 of the second vehicle, the fifth position value 1000 of the second vehicle, and the sixth position value 1010 of the second vehicle.

As a non-limiting example, the at least one processor 220 may obtain a ninth straight line 1020 by applying Equation 1 to the first position value 420 of the second vehicle and the sixth position value 1010 of the second vehicle. As a non-limiting example, the at least one processor 220 may obtain a tenth straight line by applying Equation 2 to the first position value 420 of the second vehicle, the second position value 450 of the second vehicle, the third position value 480 of the second vehicle, the fifth position value 1000 of the second vehicle, and the sixth position value 1010 of the second vehicle. As a non-limiting example, the at least one processor 220 may obtain a fourth curve by applying Equation 4 to the first position value 420 of the second vehicle, the second position value 450 of the second vehicle, the third position value 480 of the second vehicle, the fifth position value 1000 of the second vehicle, and the sixth position value 1010 of the second vehicle. As a non-limiting example, the at least one processor 220 may determine the second reference position 1030 of the second vehicle separated from the first vehicle by the reference distance using the ninth straight line 1020, the tenth straight line, or the fourth curve. However, it is not limited thereto.

For example, the at least one processor 220 may determine a direction in which the camera 115 faces using the first reference position 660 of the second vehicle and the second reference position 1030 of the second vehicle.

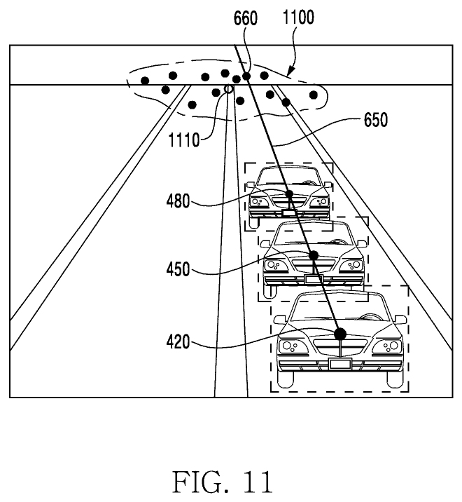

For example, the at least one processor 220 may determine a representative reference position using the first reference position 660 of the second vehicle and the second reference position 1030 of the second vehicle. For example, the at least one processor 220 may determine the direction in which the camera 115 faces using the representative reference position. Determining the representative reference position using a plurality of reference positions is illustrated in a description of FIG. 11.

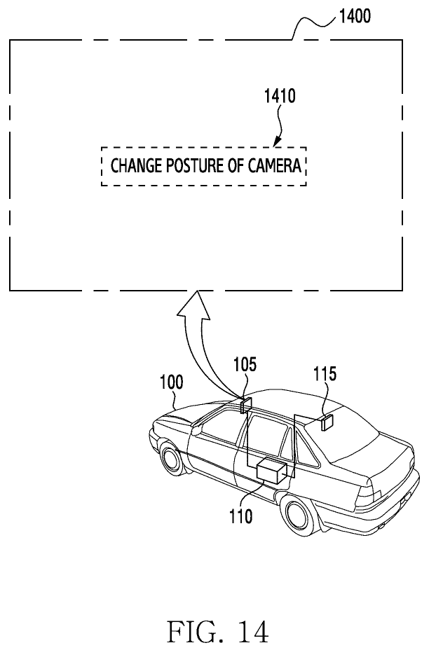

FIG. 14 illustrates an exemplary method of providing information to change a posture of a camera.

Referring to FIG. 11, at least one processor 220 may obtain a plurality of reference positions 1100. For example, the plurality of reference positions 1100 may include a reference position 660 of a second vehicle, a second reference position of the second vehicle, a reference position of a third vehicle, and another reference position of the third vehicle. For example, the plurality of reference positions 1100 may be determined to determine a position of a vanishing point of a visual object (e.g., corresponding to the second vehicle or the third vehicle) or a position close to the vanishing point of the visual object in each of a plurality of images obtained through a camera 115.

For example, the at least one processor 220 may determine a representative reference position 1110 by using the plurality of reference positions 1100. For example, the at least one processor 220 may determine a direction in which the camera faces using the representative reference position 1110.

For example, the representative reference position 1110 may be the position of the vanishing point of the visual object (e.g., corresponding to the second vehicle or the third vehicle) in each of the images obtained through the camera 115 or the position close to the vanishing point of the visual object.

For example, the representative reference position 1110 may be determined as an average value of the plurality of reference positions 1100. For example, an x-coordinate of the representative reference position 1110 may be an average value of an x-coordinate of the plurality of reference positions 1100. For example, a y-coordinate of the representative reference position 1110 may be an average value of a y-coordinate of the plurality of reference positions 1100.

For example, as the number of the plurality of reference positions 1100 increases, the average value of the plurality of reference positions 1100 may approach the vanishing point of the visual object in each of the images obtained through the camera 115. For example, as the number of the plurality of reference positions 1100 increases, the representative reference position 1110 may approach the vanishing point of the visual object in each of the images obtained through the camera 115.

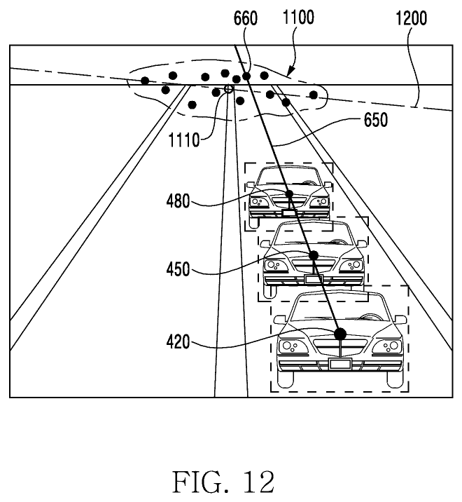

For example, the at least one processor 220 may identify a reference line using the plurality of reference positions 1100. Identifying the reference line using the plurality of reference positions 1100 is illustrated in a description of FIG. 12.

FIG. 12 illustrates an exemplary method of identifying a reference line using a plurality of reference positions.

Referring to FIG. 12, at least one processor 220 may obtain a plurality of reference positions 1100. For example, the plurality of reference positions 1100 may include a reference position 660 of a second vehicle, a second reference position of the second vehicle, a reference position of a third vehicle, and another reference position of the third vehicle. For example, the at least one processor 220 may identify a reference line 1200 using the plurality of reference positions 1100. For example, the reference line 1200 may be a vanishing line of a visual object (e.g., corresponding to the second vehicle) or a straight line close to the vanishing line of the visual object in each of images obtained through a camera 115.

For example, the at least one processor 220 may determine a direction in which the camera 115 faces using the reference line 1200.

For example, the reference line 1200 may include a representative reference position 1110.

For example, the at least one processor 220 may obtain an eleventh straight line by applying Equation 2 to the plurality of reference positions 1100.

Referring back to Equation 2, the y may indicate a y-coordinate in the image obtained through the camera 115, the y̅ may indicate an average value of a y-coordinate of the plurality of reference positions 1100, the x may indicate an x-coordinate in the image obtained through the camera 115, and the x̅ may indicate an average value of an x-coordinate of the plurality of reference positions 1100.

For example, an equation (e.g., an equation indicating a relationship between the x and the y) obtained by applying the plurality of reference positions 1100 to Equation 2 may indicate the eleventh straight line.

For example, the eleventh straight line obtained by applying Equation 2 to the plurality of reference positions 1100 may be the reference line 1200. For example, the direction in which the camera 115 faces may be determined using an inclination (e.g.,

$$\frac{\sum ( x - \overline{x} ) ( y - \overline{y} )}{\sum {( x - \overline{x} )}^{2}} )$$

of the reference line 1200.

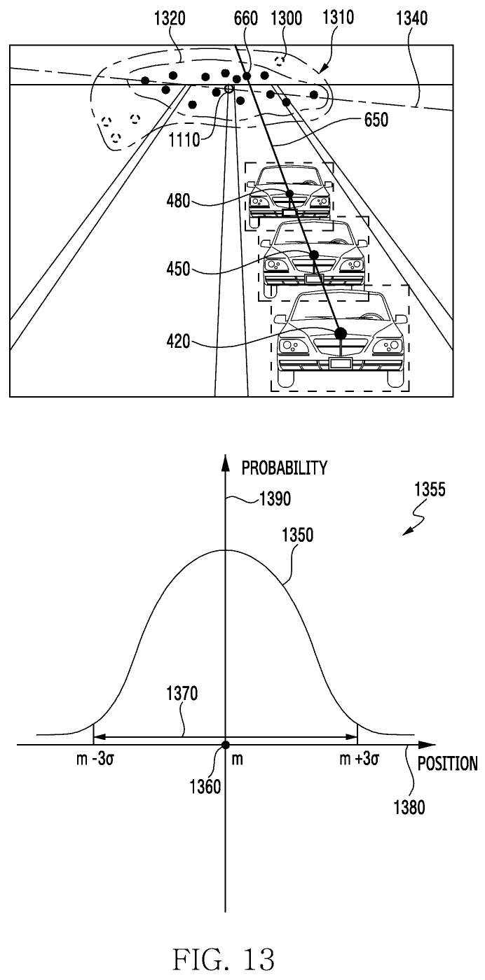

For example, a representative reference position determined by a plurality of reference positions including a noise component may not be close to a vanishing point of a visual object in each of the images obtained through the camera 115 compared to a representative reference position determined by a plurality of reference positions where the noise component is canceled. For example, a reference line identified by the plurality of reference positions including the noise component may not be close to a vanishing line of the visual object in each of the images obtained through the camera 115 compared to the reference line identified by the plurality of reference positions in which the noise component is canceled. Cancelling a noise component of the plurality of reference positions 1100 is illustrated in a description of FIG. 13.

FIG. 13 illustrates an exemplary method of determining a representative reference position and identifying a reference line by canceling a noise component with respect to a plurality of reference positions.

Referring to FIG. 13, at least one processor 220 may cancel a noise component by a statistical method with respect to a plurality of reference positions 1310.

For example, the at least one processor 220 may determine a representative reference position 1330 using reference positions 1320 in which the noise component is canceled by the statistical method among the plurality of reference positions 1310. For example, the at least one processor 220 may identify a reference line 1340 using the reference positions 1320 in which the noise component is canceled by the statistical method among the plurality of reference positions 1310.

For example, the at least one processor 220 may cancel the noise component by the statistical method using distribution of the plurality of reference positions 1310.

For example, a chart 1355 represents a change in probability in accordance with positions of the plurality of reference positions 1320. A horizontal axis 1380 in the chart 1355 indicates the positions of the plurality of reference positions 1310, and a vertical axis 1390 in the chart 1355 indicates a probability that the plurality of reference positions 1320 exist.

For example, an average position of the plurality of reference positions 1310 in the chart 1355 may be m 1360. For example, the probability that the plurality of reference positions 1310 exist may be the highest at the m 1360, which is the average position of the plurality of reference positions 1310.

For example, σ may be a standard deviation of the plurality of reference positions 1310. For example, the probability that the plurality of reference positions 1310 exist between m−3σ and m+3σ may be about 99.73%.

For example, the probability that the plurality of reference positions 1310 exist may be represented as a line 1350 in the chart 1355.

For example, the at least one processor 220 may exclude reference positions 1300 outside an interval 1370 from −3σ to +3σ at the m 1360, which is the average position of the plurality of reference positions 1310. For example, the at least one processor 220 may cancel the noise component by the statistical method by excluding the reference positions 1300 outside the interval 1370. For example, the at least one processor 220 may determine only about 99.73% of the reference positions 1320 close to the m 1360, which is the average position of the plurality of reference positions 1310, by excluding the reference positions 1300 outside the interval 1370.

For example, the representative reference position 1330 determined using the reference positions 1320 in which the noise component is canceled by the statistical method among the plurality of reference positions 1310 may be more robust to noise than a representative reference position determined using the plurality of reference positions 1310 in which the noise component is not canceled by the statistical method. For example, the representative reference position 1330 determined using the reference positions 1320 in which the noise component is canceled by the statistical method among the plurality of reference positions 1310 may be closer to a vanishing point of a visual object in each of images obtained through a camera 115 than the representative reference position determined using the plurality of reference positions 1310 in which the noise component is not canceled by the statistical method.

For example, the reference line 1340 identified using the reference positions 1320 in which the noise component is canceled by the statistical method among the plurality of reference positions 1310 may be more robust to noise than a reference line identified using the plurality of reference positions 1310 in which the noise component is not canceled by the statistical method. For example, the reference line 1340 identified using the reference positions 1320 in which the noise component is canceled by the statistical method among the plurality of reference positions 1310 may be closer to the vanishing line of the visual object in each of the images obtained through the camera 115 than the reference line identified using the plurality of reference positions 1310 in which the noise component is not canceled by the statistical method.

For example, the at least one processor 220 may determine a direction in which the camera 115 faces using the representative reference position 1330 determined using the reference positions 1320 in which the noise component is canceled by the statistical method among the plurality of reference positions 1310. For example, the at least one processor 220 may determine the direction in which the camera 115 faces using the reference line 1340 identified using the reference positions 1320 in which the noise component is canceled by the statistical method among the plurality of reference positions 1310.

For example, the at least one processor 220 may identify whether the determined direction in which the camera 115 faces is included in a reference range. For example, the reference range may include a range of a direction in which the direction in which the camera 115 faces is to be horizontal with the ground. For example, the at least one processor 220 may provide information to change a posture of the camera 115 when the determined direction in which the camera 115 faces is not included in the reference range. The least one processor 220 providing the information to change the posture of the camera 115 is illustrated in a description of FIG. 14.

FIG. 14 illustrates an exemplary method of providing information to change a posture of a camera.

Referring to FIG. 14, at least one processor 220 may determine a direction in which a camera 115 faces. The at least one processor 220 may identify whether the direction in which the camera 115 faces is included in a reference range. The at least one processor 220 may provide information to change a posture of the camera 115 based on identifying that the direction in which the camera 115 faces is not included in the reference range.

For example, the at least one processor 220 may provide the information to change the posture of the camera 115 until it is identified that the direction to which the camera 115 faces is included in the reference range.

For example, the at least one processor 220 may provide the information to change the posture of the camera 115 through a display 105. For example, the at least one processor 220 may display a screen 1400 that includes guidance 1410 to change the posture of the camera 115 on the display 105. For example, the display 105 may be included in an electronic device 110. For example, the display 105 may be connected to the electronic device 110.

For example, the at least one processor 220 may provide the information to change the posture of the camera 115 through a speaker 240. For example, the at least one processor 220 may output an audio signal including the guidance to change the posture of the camera 115 through the speaker 240. For example, the speaker 240 may be included in the electronic device 110. For example, the speaker 240 may be connected to the electronic device 110.

For example, the direction in which the camera 115 faces may be changed in the reference range by a user of a first vehicle who has been provided with the information to change the posture of the camera 115. For example, the at least one processor 220 may improve a quality of a service for autonomous driving of a first vehicle 100 based on the direction in which the camera 115 faces changed in the reference range.

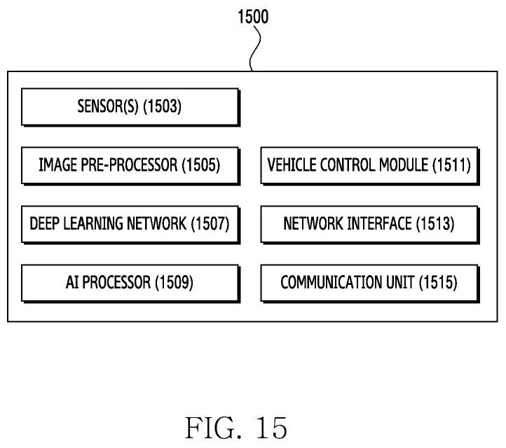

FIG. 15 illustrates an example of a block diagram illustrating an autonomous driving system of a vehicle according to an embodiment.

An autonomous driving system 1500 of the vehicle according to FIG. 15 may be a deep learning network including sensors 1503, an image pre-processor 1505, a deep learning network 1507, an artificial intelligence (AI) processor 1509, a vehicle control module 1511, a network interface 1513, and a communication unit 1515. In various embodiments, each element may be connected through various interfaces. For example, sensor data sensed and outputted by the sensors 1503 may be fed to the image pre-processor 1505. The sensor data processed by the image pre-processor 1505 may be fed to the deep learning network 1507 running on the AI processor 1509. An output of the deep learning network 1507 running by the AI processor 1509 may be fed to the vehicle control module 1511. Intermediate results of the deep learning network 1507 running on the AI processor 1509 may be fed to the AI processor 1509. In various embodiments, the network interface 1513 delivers autonomous driving route information and/or autonomous driving control commands for autonomous driving of the vehicle to internal block configurations, by performing communication with an electronic device (e.g., the electronic device 110 of FIG. 2) in the vehicle. In an embodiment, the network interface 1513 may be used to transmit the sensor data obtained through the sensor(s) 1503 to an external server. In some embodiments, the autonomous driving control system 1500 may include additional or fewer components as appropriate. For example, in some embodiments, the image pre-processor 1505 may be an optional component. For another example, a post-processing component (not illustrated) may be included in the autonomous driving control system 1500 to perform post-processing on the output of the deep learning network 1507 before the output is provided to the vehicle control module 1511.

In some embodiments, the sensors 1503 may include one or more sensors. In various embodiments, the sensors 1503 may be attached to different positions of the vehicle. The sensors 1503 may face one or more different directions. For example, the sensors 1503 may be attached to a front, sides, a rear, and/or a roof of the vehicle to face directions such as forward-facing, rear-facing, and side-facing. In some embodiments, the sensors 1503 may be image sensors such as high dynamic range cameras. In some embodiments, the sensors 1503 include non-visual sensors. In some embodiments, the sensors 1503 include RADAR, Light Detection And Ranging (LiDAR), and/or ultrasonic sensors in addition to an image sensor. In some embodiments, the sensors 1503 are not mounted on a vehicle having the vehicle control module 1511. For example, the sensors 1503 may be included as a portion of a deep learning system for capturing the sensor data and may be attached to an environment or a roadway and/or mounted on nearby vehicles.

In some embodiments, the image pre-processor 1505 may be used to pre-process the sensor data of the sensors 1503. For example, the image pre-processor 1505 may be used to preprocess the sensor data, to split the sensor data into one or more components, and/or to post-process one or more components. In some embodiments, the image pre-processor 1505 may be a graphics processing unit (GPU), a central processing unit (CPU), an image signal processor, or a specialized image processor. In various embodiments, the image pre-processor 1505 may be a tone-mapper processor for processing high dynamic range data. In some embodiments, the image pre-processor 1505 may be a component of the AI processor 1509.

In some embodiments, the deep learning network 1507 may be a deep learning network for implementing control commands for controlling an autonomous vehicle. For example, the deep learning network 1507 may be an artificial neural network such as a convolution neural network (CNN) trained by using the sensor data, and the output of the deep learning network 1507 is provided to the vehicle control module 1511.

In some embodiments, the artificial intelligence (AI) processor 1509 may be a hardware processor for running the deep learning network 1507. In some embodiments, the AI processor 1509 is a specialized AI processor for performing inference on the sensor data through the convolution neural network (CNN). In some embodiments, the AI processor 1509 may be optimized for a bit depth of the sensor data. In some embodiments, the AI processor 1509 may be optimized for deep learning computations, such as computations of a neural network including a convolution, a dot product, a vector and/or matrix computations. In some embodiments, the AI processor 1509 may be implemented through a plurality of graphics processing units (GPUs) capable of effectively performing parallel processing.

In various embodiments, the AI processor 1509 may be coupled, through an input/output interface, to memory configured to perform a deep learning analysis on the sensor data received from the sensor(s) 1503 while the AI processor 1509 is running and to provide an AI processor having commands that cause to determine a machine learning result used to operate the vehicle at least partially autonomously. In some embodiments, the vehicle control module 1511 may be used to process commands for vehicle control outputted from the artificial intelligence (AI) processor 1509 and translate the output of the AI processor 1509 into commands for controlling a module of each vehicle to control various modules of the vehicle. In some embodiments, the vehicle control module 1511 is used to control a vehicle for autonomous driving. In some embodiments, the vehicle control module 1511 may adjust steering and/or speed of the vehicle. For example, the vehicle control module 1511 may be used to control traveling of the vehicle such as deceleration, acceleration, steering, lane change, lane keeping, and the like. In some embodiments, the vehicle control module 1511 may generate control signals for controlling vehicle lighting, such as brake lights, turns signals, headlights, and the like. In some embodiments, the vehicle control module 1511 may be used to control vehicle audio-related systems such as a vehicle's sound system, vehicle's audio warnings, a vehicle's microphone system, a vehicle's horn system, and the like.

In some embodiments, the vehicle control module 1511 may be used to control notification systems, including warning systems to notify passengers and/or a driver of driving events, such as approach of an intended destination or a potential collision. In some embodiments, the vehicle control module 1511 may be used to adjust sensors, such as the sensors 1503 of the vehicle. For example, the vehicle control module 1511 may modify the orientation of the sensors 1503, change output resolution and/or a format type of the sensors 1503, increase or decrease a capture rate, adjust a dynamic range, and adjust a focus of the camera. In addition, the vehicle control module 1511 may turn on/off the operation of sensors individually or collectively.

In some embodiments, the vehicle control module 1511 may be used to change parameters of the image pre-processor 1505 in a method such as modifying a frequency range of filters, adjusting features and/or edge detection parameters for object detection, or adjusting channels and a bit depth, and the like. In various embodiments, the vehicle control module 1511 may be used to control autonomous driving of the vehicle and/or a driver assistance function of the vehicle.

In some embodiments, the network interface 1513 may be responsible for an internal interface between block configurations of the autonomous driving control system 1500 and the communication unit 1515. Specifically, the network interface 1513 may be a communication interface for receiving and/or transmitting data including voice data. According to various embodiments, the network interface 1513 may be connected to external servers to connect voice calls, receive and/or transmit text messages, transmit sensor data, update software of the vehicle with the autonomous driving system, or update software of the autonomous driving system of the vehicle, through the communication unit 1515.

In various embodiments, the communication unit 1515 may include various wireless interfaces of cellular or WiFi methods. For example, the network interface 1513 may be used to receive an update on operating parameters and/or commands for the sensors 1503, the image pre-processor 1505, the deep learning network 1507, the AI processor 1509, and the vehicle control module 1511 from an external server connected through the communication unit 1515. For example, a machine learning model of the deep learning network 1507 may be updated by using the communication unit 1515. According to another example, the communication unit 1515 may be used to update operating parameters of the image pre-processor 1505, such as image processing parameters, and/or firmware of the sensors 1503.

In another embodiment, the communication unit 1515 may be used to activate communications for an emergency contact and emergency services in an accident or near-accident event. For example, in a crash event, the communication unit 1515 may be used to call emergency services for assistance and may be used to externally notify emergency services of crash details and a position of the vehicle. In various embodiments, the communication unit 1515 may update or obtain an expected arrival time and/or a destination position.

According to an embodiment, the autonomous driving system 1500 illustrated in FIG. 15 may be configured with an electronic device 110 of the vehicle. According to an embodiment, when an autonomous driving release event occurs from a user during autonomous driving of the vehicle, the AI processor 1509 of the autonomous driving system 1500 may control the software of the vehicle autonomous driving to learn by controlling information related to the autonomous driving release event to be inputted as training set data of the deep learning network.

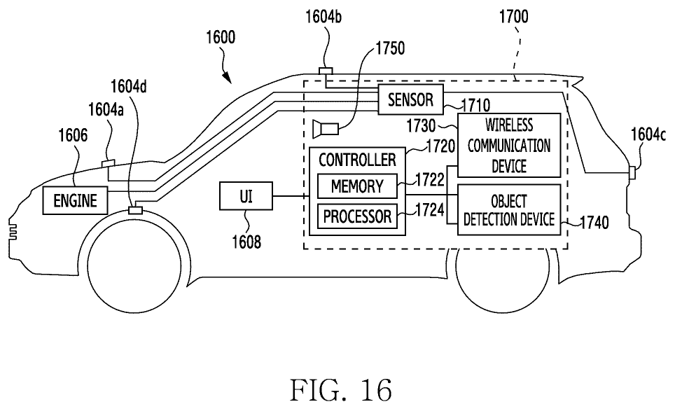

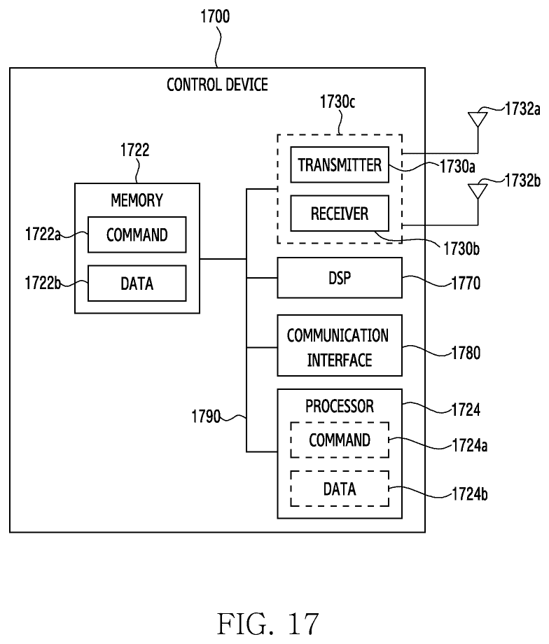

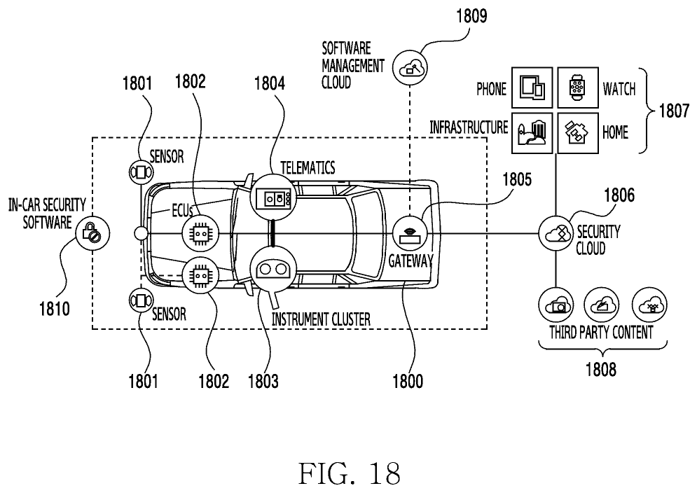

FIGS. 16 and 17 illustrate an example of a block diagram indicating an autonomous driving moving object according to an embodiment. FIG. 18 illustrates an example of a gateway related to a user device according to various embodiments.

Referring to FIG. 16, an autonomous moving object 1600 according to the present embodiment may include a control device 1700, sensing modules 1604a, 1604b, 1604c, and 1604d, an engine 1606, and a user interface 1608.

The autonomous driving moving object 1600 may have an autonomous driving mode or a manual mode. As an example, according to a user input received through the user interface 1608, it may be switched from the manual mode to the autonomous driving mode or may be switched from the autonomous driving mode to the manual mode.

In a case that the moving object 1600 operates in the autonomous driving mode, the autonomous driving moving object 1600 may operate under control of the control device 1700.

In the present embodiment, the control device 1700 may include a controller 1720, including memory 1722 and a processor 1724, a sensor 1710, a communication device 1730, and an object detection device 1740.

Herein, the object detection device 1740 may perform all or a portion of a function of a distance measurement device.

That is, in the present embodiment, the object detection device 1740 is a device for detecting an object positioned outside the moving object 1600, and the object detection device 1740 may detect the object positioned outside the moving object 1600 and generate object information according to the detection result.

The object information may include information on existence or nonexistence of the object, position information of the object, distance information between the moving object and the object, and relative speed information between the moving object and the object.

The object may include various objects positioned outside the moving object 1600, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object positioned around a road and fixed to the ground. For example, the structure may include a streetlamp, a street tree, a building, a power pole, a traffic light, and a bridge. The landform may include a mountain, a hill, and the like.

Such the object detection device 1740 may include a camera module. The controller 1720 may extract object information from an external image photographed by the camera module and enable the controller 1720 to process information thereon.

In addition, the object detection device 1740 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1600 and the object, and may control an operation of the moving object based on the distance calculated in connection with the control device 1700 of the autonomous driving moving object 1600.

As an example, in a case that there is a probability of a collision according to the distance between the autonomous driving moving object 1600 and the object, the autonomous driving moving object 1600 may control a brake to lower a speed or stop. As another example, in a case that the object is a moving object, the autonomous driving moving object 1600 may control a traveling speed of the autonomous driving moving object 1600 to maintain a predetermined distance or more from the object.

This distance measurement device according to an embodiment of the present invention may be configured as a module in the control device 1700 of the autonomous driving moving object 1600. That is, the memory 1722 and the processor 1724 of the control device 1700 may be configured to implement a collision prevention method according to the present invention in software.

In addition, the sensor 1710 may obtain various sensing information by connecting an internal/external environment of the moving object with the sensing modules 1604a, 1604b, 1604c, and 1604d. Herein, the sensor 1710 may include a posture sensor (e.g., a yaw sensor, a roll sensor, a pitch sensor), a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1710 may obtain sensing signals for moving object posture information, moving object collision information, moving object direction information, moving object position information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1710 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1710 may generate moving object state information based on sensing data.

The wireless communication device 1730 is configured to implement wireless communication between the autonomous driving moving object 1600. For example, The wireless communication device 1730 enables the autonomous driving moving object 1600 to communicate with a mobile phone of a user, or the other wireless communication device 1730, another moving object, a central device (a traffic control device), a server, and the like. The wireless communication device 1730 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1600 to implement communication between moving objects through the wireless communication device 1730. That is, the wireless communication device 1730 may perform communication with another moving object and other moving objects on the road through vehicle-to-vehicle (V2V) communication. The autonomous driving moving object 1600 may transmit and receive information such as driving warning and traffic information through the vehicle-to-vehicle (V2V) communication, and it is also possible to request information from, or receive a request from the other moving object. For example, the wireless communication device 1730 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1730.

In addition, the wireless communication device 1730 may obtain information generated from various mobilities, including infrastructure (a traffic light, a CCTV, a RSU, a eNode B, and the like) positioned on the road or other autonomous driving/non-autonomous driving vehicles, and the like, through a non-terrestrial network other than a terrestrial network, as information for autonomous driving performance of the autonomous driving moving object 1600.

For example, the wireless communication device 1730 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1600.

For example, the wireless communication device 1730 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 1720 may select a platform that may properly perform NTN communication in consideration of various information such as a position of the autonomous driving moving object 1600, current time, and available power, and control the wireless communication device 1730 to perform wireless communication with the selected platform.

In the present embodiment, the controller 1720, which is a unit that controls an overall operation of each unit in the moving object 1600, may be configured by a manufacturer of the moving object when manufacturing or may be additionally configured to perform a function of autonomous driving after manufacturing. In addition, a configuration for performing a continuous additional function may be included through an upgrade of the controller 1720 configured when manufacturing. This controller 1720 may also be named an Electronic Control Unit (ECU).

The controller 1720 may collect various data from the connected sensor 1710, the object detection device 1740, the communication device 1730, and may transmit a control signal to the sensor 1710, the engine 1606, the user interface 1608, the communication device 1730, and the object detection device 1740 included in other components in the moving object based on the collected data. In addition, although not illustrated, the control signal may also be transmitted to an acceleration device, a braking system, a steering device, or a navigation device related to traveling of the moving object.

In the present embodiment, the controller 1720 may control the engine 1606, for example, may detects a speed limit of a road on which the autonomous driving moving object 1600 is traveling, and may control the engine 1606 so that a traveling speed does not exceed the speed limit or may control the engine 1606 to accelerate the traveling speed of the autonomous driving moving object 1600 in a range that does not exceed the speed limit.

In addition, when the autonomous driving moving object 1600 approaches a lane or leaves the lane while the autonomous driving moving object 1600 is traveling, the controller 1720 may determine whether such lane approaching and leaving are due to a normal traveling situation or another traveling situation, and may control the engine 1606 to control the traveling of the moving object according to the determination result. Specifically, the autonomous driving moving object 1600 may detect lanes formed on both sides of the lane in which the moving object is traveling. In this case, the controller 1720 may determine whether the autonomous driving moving object 1600 approaches the lane or leaves the lane, and if it is determined that the autonomous driving moving object 1600 approaches the lane or leaves the lane, the controller 1720 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1600 is approaching the lane or leaving the lane in a situation in which the moving object does not need to change lane, the controller 1720 may control the traveling of the autonomous driving moving object 1600 so that the autonomous driving moving object 1600 does not leave the lane and normally travels in a corresponding vehicle.

In a case that another moving object or an obstacle exists in a front of the moving object, it may control the engine 1606 or the braking system to decelerate the driving moving object, and may control a trajectory, a traveling route, and a steering angle in addition to speed. Alternatively, the controller 1720 may control the traveling of the moving object by generating a necessary control signal according to recognition information of another external environment, such as a traveling lane or a driving signal of the moving object.

In addition to generating its own control signal, the controller 1720 may also control the traveling of the moving object by performing communication with a nearby moving object or a central server and transmitting a command to control peripheral devices through the received information.

In addition, since accurate recognition of the moving object or lane according to the present embodiment may be difficult in a case that a position of the camera module 1750 changes or an angle of view changes, the controller 1720 may generate a control signal for controlling to perform calibration of the camera module 1750 to prevent this. Therefore, in the present embodiment, by generating the calibration control signal to the camera module 1750, the controller 1720 may continuously maintain a normal mounting position, a direction, an angle of view, and the like of the camera module 1750 even when a mounting position of the camera module 1750 is changed due to vibration or impact generated by a movement of the autonomous driving moving object 1600. In a case that an initial mounting position, a direction, and an angle of view information of the camera module 1750 that are pre-stored, and an initial mounting position, a direction, an angle of view information, and the like of the camera module 1750 measured while the autonomous driving moving object 800 is traveling are changed by a threshold value or more, the controller 1720 may generate the control signal to perform the calibration of the camera module 1750.

In the present embodiment, the controller 1720 may include the memory 1722 and the processor 1724. The processor 1724 may execute software stored in the memory 1722 according to the control signal of the controller 1720. Specifically, the controller 1720 may store data and commands for performing the lane detection method according to the present invention in the memory 1722, and the commands may be executed by the processor 1724 to implement one or more methods disclosed herein.

In this case, the memory 1722 may be stored in a recording medium executable by the non-volatile processor 1724. The memory 1722 may store software and data through an appropriate internal/external device. The memory 1722 may be configured with random access memory (RAM), read only memory (ROM), a hard disk, and a memory 1722 device connected with a dongle.

The memory 1722 may at least store an Operating system (OS), a user application, and executable commands. The memory 1722 may also store application data and array data structures.

The processor 1724, which is a microprocessor or an appropriate electronic processor, may be a controller, a microcontroller, or a state machine.

The processor 1724 may be implemented as a combination of computing devices, and the computing device may be configured with a digital signal processor, a microprocessor, or an appropriate combination thereof.

Meanwhile, the autonomous driving moving object 1600 may further include the user interface 1608 for a user input with respect to the above-described control device 1700. The user interface 1608 may enable a user to input information with appropriate interaction. For example, it may be implemented as a touch screen, a keypad, or an operation button, and the like. The user interface 1608 may transmit an input or a command to the controller 1720, and the controller 1720 may perform a control operation of the moving object in response to the input or the command.

In addition, the user interface 1608, which is a device outside the autonomous driving moving object 1600, may perform communication with the autonomous driving moving object 1600 through the wireless communication device 1730. For example, the user interface 1608 may be linkable with a mobile phone, a tablet, or another computer device.

Furthermore, in the present embodiment, the autonomous driving moving object 1600 has been described as including the engine 1606, but it may also include another type of a propulsion system. For example, the moving object may be operated with electrical energy, and may be operated through hydrogen energy or a hybrid system combining them. Therefore, the controller 1720 may include a propulsion mechanism according to the propulsion system of the autonomous driving moving object 1600 and may provide a control signal according to this to components of each propulsion mechanism.

Hereinafter, a detailed configuration of the control device 1700 according to the present invention according to the present embodiment will be described in more detail with reference to FIG. 17.

A control device 1700 includes a processor 1724. The processor 1724 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1724 is used as a combination of a plurality of processors.

The control device 1700 also includes memory 1722. The memory 1722 may be any electronic component capable of storing electronic information. The memory 1722 may also include a combination of the memories 1722 in addition to single memory.

Data and commands 1722a for performing a distance measuring method of a distance measuring device according to the present invention may be stored in the memory 1722. When the processor 1724 executes the commands 1722a, all or a portion of the commands 1722a and the data 1722b required for performing a command may be loaded 1724a and 1724b onto the processor 1724.

The control device 1700 may include a transmitter 1730a, a receiver 1730b, or a transceiver 1730c for permitting transmission and reception of signals. One or more antennas 1732a and 1732b may be electrically connected to the transmitter 1730a, the receiver 1730b, or each transceiver 1730c, and may further include antennas.

The control device 1700 may include a digital signal processor (DSP) 1770. Through the DSP 1770, the digital signal may be quickly processed by a moving object.

The control device 1700 may include a communication interface 1780. The communication interface 1780 may include one or more ports and/or communication modules for connecting other devices to the control device 1700. The communication interface 1780 may enable a user and the control device 1700 to interact with each other.

Various configurations of the control device 1700 may be connected together by one or more buses 1790, and the buses 1790 may include a power bus, a control signal bus, a state signal bus, a data bus, and the like. Under a control of the processor 1724, configurations may transmit mutual information through the bus 1790 and perform a desired function.

Meanwhile, in various embodiments, the control device 1700 may be related to a gateway for communication with a security cloud. For example, referring to FIG. 18, the control device 1700 may be related to a gateway 1805 for providing information obtained from at least one of components 1001 to 1004 of a vehicle 1800 to a security cloud 1806. For example, the gateway 1805 may be included in the control device 1700. For another example, the gateway 1805 may be configured as a separate device in the vehicle 1800 that is distinguished from the control device 1700. The gateway 1805 connects a network in the vehicle 1800 secured by a software management cloud 1809, the security cloud 1806, and in-car security software 1810, having different networks, to enable communication.

For example, a component 1801 may be a sensor. For example, the sensor may be used to obtain information on at least one of a state of the vehicle 1800 or a state around the vehicle 1800. For example, the component 1801 may include a sensor.

For example, a component 1802 may be electronic control units (ECUs). For example, the ECUs may be used for engine control, transmission control, airbag control, and tire pressure management.

For example, a component 1803 may be an instrument cluster. For example, the instrument cluster may mean a panel positioned in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1800, visual elements for indicating an amount of remaining fuel, visual elements for indicating a state of a gear, or visual elements for indicating information obtained through the component 1801.

For example, a component 1804 may be a telematics device. For example, the telematics device may mean a device that provides various mobile communication services, such as position information and safe driving in the vehicle 1800 by coupling wireless communication technology and global positioning system (GPS) technology. For example, the telematics device may be used to connect the vehicle 1800 with a driver, a cloud (e.g., the security cloud 1806), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1800.

For example, the gateway 1805 may be used to connect a network within the vehicle 1800, and the software management cloud 1809 and the secure cloud 1806, which are a network outside the vehicle. For example, the software management cloud 1809 may be used to update or manage at least one software necessary for traveling and managing the vehicle 1800. For example, the software management cloud 1809 may be linked to the in-car security software 1810 installed in the vehicle. For example, the in-car security software 1810 may be used to provide a security function in the vehicle 1800. For example, the in-car security software 1810 may encrypt data transmitted and received through an in-car network using an encryption key obtained from an external authorized server for encryption of the in-car network. In various embodiments, the encryption key used by the in-car security software 1810 may be generated corresponding to vehicle identification information (a vehicle license plate, a vehicle identification number (VIN)) or information (e.g., user identification information) uniquely assigned to each user.

In various embodiments, the gateway 1805 may transmit the data encrypted by the in-car security software 1810 based on the encryption key to the software management cloud 1809 and/or the security cloud 1806. The software management cloud 1809 and/or the security cloud 1806 may identify the data received from which vehicle or which user by decrypting the data encrypted by the encryption key of the in-car security software 1810. For example, since the decryption key is a unique key corresponding to the encryption key, the software management cloud 1809 and/or the security cloud 1806 may identify a transmission entity (e.g., the vehicle or the user) of the data based on the data decrypted through the decryption key.

For example, the gateway 1805 may be configured to support in-car security software 1810 and may be related to the control device 1700. For example, the gateway 1805 may be related to the control device 1700 to support a connection between a client device 1807 and the control device 1700 connected to the security cloud 1806. For another example, the gateway 1805 may be related to the control device 1700 to support a connection between a third-party cloud 1808 connected to the security cloud 1806 and the control device 1700. However, it is not limited thereto.

In various embodiments, the gateway 1805 may be used to connect the vehicle 1800 with the software management cloud 1809 to manage operating software of the vehicle 1800. For example, the software management cloud 1809 may monitor whether updating the operating software of the vehicle 1800 is required, and based on monitoring that the updating the operating software of the vehicle 1800 is required, provide data for the updating the operating software of the vehicle 1800 through the gateway 1805. For another example, the software management cloud 1809 may receive a user request for updating the operating software of the vehicle 1800 from the vehicle 1800 through the gateway 1805, and provide data for updating the operating software of the vehicle 1800 based on the reception. However, it is not limited thereto.

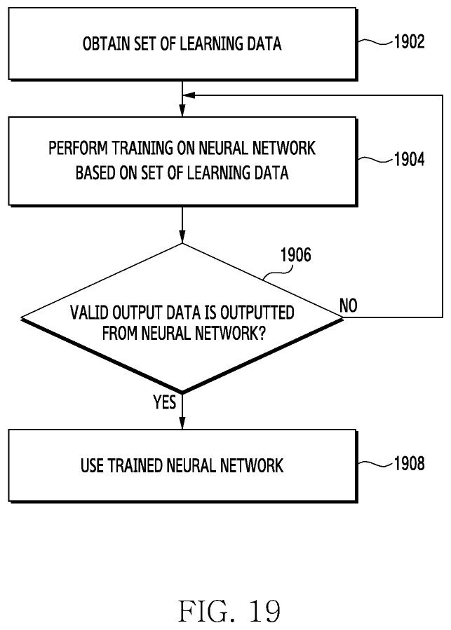

FIG. 19 is a diagram for explaining an operation of an electronic device for training a neural network based on a set of learning data, according to an embodiment.

An operation described with reference to FIG. 19 may be performed by the above-described electronic device (e.g., the electronic device 110 of FIG. 2).

Referring to FIG. 19, in operation 1902, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a position, a width, a height, and/or a size of a visual object corresponding to the subject within the image. The set of the learning data identified through the operation 1902 may include pairs of a plurality of learning data. In the example of training the neural network for the image recognition, the set of the learning data identified by the electronic device may include a plurality of images and ground truth data corresponding to each of the plurality of images.

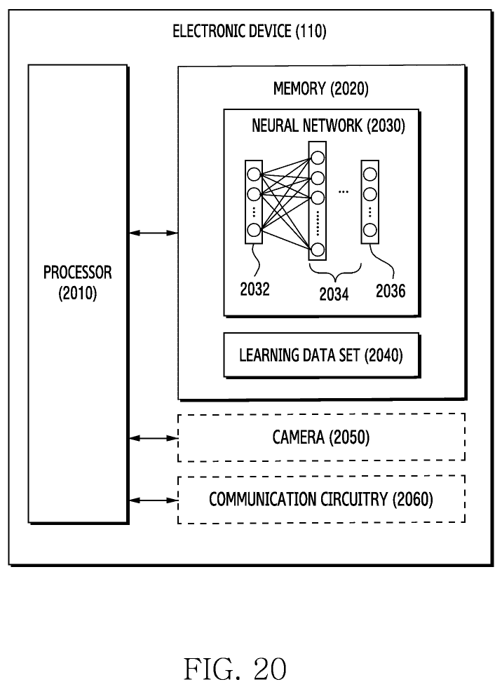

Referring to FIG. 19, in operation 1904, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 20. From an output layer of the neural network receiving the input data through the input layer, the electronic device may obtain output data of the neural network corresponding to the input data.

In an embodiment, the training of the operation 1904 may be performed based on a difference between the output data and the ground truth data included in the learning data and corresponding to the input data. For example, the electronic device may adjust one or more parameters related to the neural network (e.g., a weight to be described later with reference to FIG. 20) to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 19, in operation 1906, according to an embodiment, the electronic device may identify whether valid output data is outputted from the neural network trained by the operation 1904. The output data being valid may mean that the difference (or the cost function) between the output data and the ground truth data satisfies a condition set for use of the neural network. For example, in a case that an average value and/or the maximum value of the difference between the output data and the ground truth data is less than or equal to a designated threshold value, the electronic device may determine that the valid output data is outputted from the neural network.

In a case that the valid output data is not outputted from the neural network (1906—NO), the electronic device may repeatedly perform training of the neural network based on the operation 1904. An embodiment is not limited thereto, and the electronic device may repeatedly perform the operations 1902 and 1904.

In a state in which the valid output data is obtained from the neural network (1906—YES), based on operation 1908, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

FIG. 20 is a block diagram of an electronic device according to an embodiment.

An electronic device 110 of FIG. 20 may include the above-described electronic device.

For example, an operation described with reference to FIG. 19 may be performed by the electronic device 110 of FIG. 20 and/or a processor 2010 of FIG. 20.

Referring to FIG. 20, the processor 2010 of the electronic device 110 may perform computations related to a neural network 2030 stored in memory 2020. The processor 2010 may include at least one of a central processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 20, the processor 2010 may identify the neural network 2030 stored in the memory 2020. The neural network 2030 may include a combination of an input layer 2032, one or more hidden layers 2034 (or intermediate layers), and an output layer 2036. The above-described layers (e.g., the input layer 2032, the one or more hidden layers 2034, and the output layer 2036) may include a plurality of nodes. The number of hidden layers 2034 may vary according to an embodiment, and the neural network 2030 including the plurality of hidden layers 2034 may be referred to as a deep neural network. An operation of training the deep neural network may be referred to as deep learning.

In an embodiment, in a case that the neural network 2030 has a structure of a feed forward neural network, a first node included in a specific layer may be connected to all of second nodes included in another layer before the specific layer. In the memory 2020, parameters stored for the neural network 2030 may include weights assigned to connections between the second nodes and the first node. In the neural network 2030 having the structure of the feed forward neural network, a value of the first node may correspond to a weighted sum of values assigned to the second nodes, based on the weights assigned to the connections connecting the second nodes and the first node.

In an embodiment, in a case that the neural network 2030 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 2020, the parameters stored for the neural network 2030 may include weights indicating the filter. The filter may include, among the second nodes, one or more nodes to be used to calculate a weighted sum of the first node, and weights corresponding to each of the one or more nodes.

According to an embodiment, the processor 2010 of the electronic device 110 may perform training on the neural network 2030 using a learning data set 2040 stored in the memory 2020. Based on the learning data set 2040, the processor 2010 may adjust one or more parameters stored in the memory 2020 for the neural network 2030 by performing the operation described with reference to FIG. 19.

According to an embodiment, the processor 2010 of the electronic device 110 may perform object detection, object recognition, and/or object classification using the neural network 2030 trained based on the learning data set 2040. The processor 2010 may input an image (or a video) obtained through a camera 2050 into the input layer 2032 of the neural network 2030. Based on the input layer 2032 to which the image is inputted, the processor 2010 may obtain a set (e.g., the output data) of values of the nodes of the output layer 2036 by sequentially obtaining values of the nodes of the layers included in the neural network 2030. The output data may be used as a result of inferring information included in the image using the neural network 2030. An embodiment is not limited thereto, and the processor 2010 may input an image (or a video) obtained from an external electronic device connected to the electronic device 110 through communication circuitry 2060 to the neural network 2030.

In an embodiment, the neural network 2030 trained to process an image may be used to identify a region corresponding to a subject within the image (object detection), and/or to identify a class of the subject represented within the image (object recognition and/or object classification). For example, the electronic device 110 may segment the region corresponding to the subject within the image based on a quadrangle shape such as a bounding box, using the neural network 2030. For example, the electronic device 110 may identify at least one class matching the subject among a plurality of designated classes using the neural network 2030.

For example, an electronic device may cause the electronic device to determine a reference position of the second vehicle separated from a first vehicle by a reference distance and to determine a direction in which the camera faces using the reference position. For example, the electronic device may require a method of obtaining, using the plurality of images obtained using the camera, a plurality of first values indicating a size of the second vehicle, identifying whether a range including second values is maintained until a threshold time elapses, wherein the second values are a portion of the plurality of the first values and are continually obtained while the plurality of the first values are obtained, based on the range maintained until the threshold time elapses, determining, using position values of the second vehicle respectively related to the second values, a reference position of the second vehicle separated from the first vehicle by a reference distance, and determining, using the reference position, the direction in which the camera faces.

As described above, an electronic device may comprise memory, storing instructions, comprising one or more storage media, a camera, and at least one processor comprising processing circuitry. The instructions, when executed by the at least one processor individually or collectively, may cause the electronic device to, while a relative distance between a first vehicle including the electronic device and a second vehicle different from the first vehicle is changed, obtain, using the camera, a plurality of images. The instructions, when executed by the at least one processor individually or collectively, may cause the electronic device to obtain, using the plurality of images obtained using the camera, a plurality of first values indicating a size of the second vehicle. The instructions, when executed by the at least one processor individually or collectively, may cause the electronic device to identify whether a range including second values is maintained until a threshold time elapses, wherein the second values are a portion of the plurality of the first values and are continually obtained while the plurality of the first values are obtained. The instructions, when executed by the at least one processor individually or collectively, may cause the electronic device to, based on the range maintained until the threshold time elapses, determine, using position values of the second vehicle respectively related to the second values, a reference position of the second vehicle separated from the first vehicle by a reference distance. The instructions, when executed by the at least one processor individually or collectively, may cause the electronic device to, based on the range maintained until the threshold time elapses, determine, using the reference position, a direction in which the camera faces.

For example, the instructions, when executed by the at least one processor individually or collectively, may cause the electronic device to, based on identifying that the range is extended in accordance with obtaining a value higher than all the second values or lower than all the second values before the threshold time elapses, delay determining the direction in which the camera faces by identifying whether the extended range, including another portion of the plurality of first values that are continually obtained, is maintained until the threshold time elapses.

For example, the instructions, when executed by the at least one processor individually or collectively, may cause the electronic device to, based on identifying that the range is extended in accordance with obtaining a value higher than all the second values or lower than all the second values before the threshold time elapses, delay determining the direction in which the camera faces by identifying whether the extended range, including another portion of the plurality of first values that are continually obtained, is maintained until the threshold time elapses. The value higher than all the second values or lower than all the second values may be included in the another portion of the plurality of first values.

For example, the instructions, when executed by the at least one processor individually or collectively, may cause the electronic device to, based on identifying that another threshold time elapses since obtaining the plurality of first values while identifying whether the extended range is maintained until the threshold time elapses, determine, using a minimum value of the plurality of first values, the reference position. The instructions, when executed by the at least one processor individually or collectively, may cause the electronic device to determine, using the reference position, the direction in which the camera faces.

For example, each of the plurality of the first values may indicate a height of a bounding box defined along a boundary of a visual object corresponding to the second vehicle in each of the plurality of images. The position values may indicate central points of the bounding box.

For example, the instructions, when executed by the at least one processor individually or collectively, may cause the electronic device to, based on obtaining a position value from among the position values, cancel a noise component of a route represented by the position values using a weighted sum of at least one position value from among the obtained position value and position values obtained before the obtained position value.

For example, the reference position may be a first reference position. The instructions, when executed by the at least one processor individually or collectively, may cause the electronic device to, based on identifying that the range is extended in accordance with obtaining a value higher than all the second values or lower than all the second values as the second values of the range after the range is maintained until the threshold time elapses, identify whether the extended range including third values is maintained until the threshold time elapses. The third values may be continually obtained while the plurality of first values are obtained, may be a portion of the plurality of first values, and may include the second values. The instructions, when executed by the at least one processor individually or collectively, may cause the electronic device to, based on the range maintained until the threshold time elapses, determine, using the position values respectively related to the third values, a second reference position of the second vehicle separated from the first vehicle by the reference distance. The instructions, when executed by the at least one processor individually or collectively, may cause the electronic device to, based on the range maintained until the threshold time elapses, determine, using the first reference position of the second vehicle and the second reference position of the second vehicle, the direction in which the camera faces. The value higher than all the second values or lower than all the second values may be included in the third values of the plurality of first values.

For example, the instructions, when executed by the at least one processor individually or collectively, may cause the electronic device to identify a reference line applied with respect to at least a portion of the plurality images by connecting the first reference position of the second vehicle to the second reference position of the second vehicle. The instructions, when executed by the at least one processor individually or collectively, may cause the electronic device to determine the direction in which the camera faces in accordance with the reference line applied with respect to the at least a portion of the plurality of images.

For example, the instructions, when executed by the at least one processor individually or collectively, may cause the electronic device to perform noise cancelling by a statistical method for determining the first reference position of the second vehicle and the second reference position of the second vehicle.

For example, the range may be a first range, the reference position may be a first reference position, and the instructions, when executed by the at least one processor individually or collectively, may cause the electronic device to obtain, using the plurality of images, a plurality of third values indicating a size of a third vehicle different from the first vehicle and the second vehicle. The instructions, when executed by the at least one processor individually or collectively, may cause the electronic device to identify whether a second range, including fourth values that are a portion of the plurality of third values and are continually obtained while the plurality of third values are obtained, is maintained until the threshold time elapses. The instructions, when executed by the at least one processor individually or collectively, may cause the electronic device to, based on identifying that the second range is maintained until the threshold time elapses, determine, using position values of the third vehicle respectively related to the fourth values, a second reference position of the third vehicle separated from the first vehicle by the reference distance. The instructions, when executed by the at least one processor individually or collectively, may cause the electronic device to, based on identifying that the second range is maintained until the threshold time elapses, determine, using the first reference position of the second vehicle and the second refence position of the third vehicle, the direction in which the camera faces.

For example, the instructions, when executed by the at least one processor individually or collectively, may cause the electronic device to identify a reference line applied with respect to at least a portion of the plurality of images by connecting the first reference position of the second vehicle and the second reference position of the third vehicle. For example, the instructions, when executed by the at least one processor individually or collectively, may cause the electronic device to determine the direction in which the camera faces along the reference line applied with respect to the at least a portion of the plurality of images.

For example, the instructions, when executed by the at least one processor individually or collectively, may cause the electronic device to perform noise cancelling by a statistical method for determining the first reference position of the second vehicle and the second reference position of the third vehicle.

For example, the instructions, when executed by the at least one processor individually or collectively, may cause the electronic device to identify whether the direction in which the camera faces is included in a reference range. The instructions, when executed by the at least one processor individually or collectively, may cause the electronic device to, based on the direction out of the reference range, provide information to change a posture of the camera.

For example, the instructions, when executed by the at least one processor individually or collectively, may cause the electronic device to, based on the direction included in the reference range, refrain from providing the information.

For example, the instructions, when executed by the at least one processor individually or collectively, may cause the electronic device to control a display of the electronic device or a display device connected to the electronic device for displaying guidance to change the posture of the camera.

For example, the instructions, when executed by the at least one processor individually or collectively, may cause the electronic device to control a speaker of the electronic device for outputting the guidance to change the posture of the camera.

As described above, an electronic device may comprise memory, storing instructions, comprising one or more storage media, a camera, and at least one processor comprising processing circuitry. The instructions, when executed by the at least one processor individually or collectively, may cause the electronic device to, while a relative distance between a first vehicle including the electronic device and a second vehicle different from the first vehicle, obtain, using the camera, a plurality of images. The instructions, when executed by the at least one processor individually or collectively, may cause the electronic device to obtain, using the plurality of images obtained using the camera, a plurality of first values indicating a size of the second vehicle. The instructions, when executed by the at least one processor individually or collectively, may cause the electronic device to identify whether a range including second values is maintained until a threshold time elapses, wherein the second values are a portion of the plurality of the first values and are continually obtained while the plurality of the first values are obtained. The instructions, when executed by the at least one processor individually or collectively, may cause the electronic device to, based on identifying that the range is maintained until the threshold time elapses, determine a direction in which the camera faces using a reference position obtained using the range. The instructions, when executed by the at least one processor individually or collectively, may cause the electronic device to, based on identifying that the range is maintained until the threshold time elapses, provide information to change a posture of the camera in accordance with the determined direction. The instructions, when executed by the at least one processor individually or collectively, may cause the electronic device to, based on identifying that the range is extended in accordance with obtaining a value higher than all the second values or lower than all the second values as a value from among the plurality of first values before the threshold time elapses, delay determining the direction in which the camera faces.

For example, the instructions, when executed by the at least one processor individually or collectively, may cause the electronic device to, based on obtaining a value from among position values of the second vehicle respectively related to the second values, cancel a noise component of a route represented by the position values using a weighted sum of at least one position value from among the obtained position value and position values obtained before the obtained position value.

For example, the reference position may be a first reference position, and the instructions, when executed by the at least one processor individually or collectively, may cause the electronic device to, based on identifying that the range is extended in accordance with obtaining a value higher than all the second values or lower than all the second values after the range is maintained until the threshold time elapses, identify whether the extended range including third values is maintained until the threshold time elapses. The third values may be continually obtained while the plurality of first values are obtained, may be a portion of the plurality of first values, and may include the second values. The instructions, when executed by the at least one processor individually or collectively, may cause the electronic device to, based on identifying that the range is maintained until the threshold time elapses, determine the direction in which the camera faces using the first reference position and a second reference position obtained using the extended range. The instructions, when executed by the at least one processor individually or collectively, may cause the electronic device to, based on identifying that the range is maintained until the threshold time elapses, provide the information to change the posture of the camera in accordance with the determined direction. The instructions, when executed by the at least one processor individually or collectively, may cause the electronic device to, based on identifying that the extended range is extended in accordance with obtaining a value higher than all the third values or lower than all the third values as a value from among the plurality of first values before the threshold time elapses, delay determining the direction in which the camera faces.

For example, the range may be a first range. The reference position may be a first reference position. The instructions, when executed by the at least one processor individually or collectively, may cause the electronic device to obtain, using the plurality of images, a plurality of third values indicating a size of a third vehicle different from the first vehicle and the second vehicle. The instructions, when executed by the at least one processor individually or collectively, may cause the electronic device to identify whether a second range, including fourth values that are a portion of the plurality of third values and are continually obtained while the plurality of third values are obtained, is maintained until the threshold time elapses. The instructions, when executed by the at least one processor individually or collectively, may cause the electronic device to, based on identifying that the second range is maintained until the threshold time elapses, determine the direction in which the camera faces using the first reference position obtained using the first range and a second reference position obtained using the second range. The instructions, when executed by the at least one processor individually or collectively, may cause the electronic device to provide the information to change the posture of the camera in accordance with the determined direction. The instructions, when executed by the at least one processor individually or collectively, may cause the electronic device to, based on identifying that the second range is extended in accordance with obtaining a value higher than all the fourth values or lower than all the fourth values as a value from among the plurality of third values before the threshold time elapses, delay determining the direction in which the camera faces.

As described above, a method may be executed in an electronic device comprising a camera. The method may comprise, while a relative distance between a first vehicle including the electronic device and a second vehicle different from the first vehicle is changed, obtaining, using the camera, a plurality of images. The method may comprise obtaining, using the plurality of images obtained using the camera, a plurality of first values indicating a size of the second vehicle. The method may comprise identifying whether a range including second values is maintained until a threshold time elapses, wherein the second values are a portion of the plurality of the first values and are continually obtained while the plurality of the first values are obtained. The method may comprise, based on the range maintained until the threshold time elapses, determining, using position values of the second vehicle respectively related to the second values, a reference position of the second vehicle separated from the first vehicle by a reference distance. The method may comprise determining, using the reference position, a direction in which the camera faces.

For example, the method may comprise, based on identifying that the range is extended in accordance with obtaining a value higher than all the second values or lower than all the second values before the threshold time elapses, delaying determining the direction in which the camera faces by identifying whether the extended range, including another portion of the plurality of first values that are continually obtained, is maintained until the threshold time elapses. The value higher than all the second values or lower than all the second values may be included in the another portion of the plurality of first values.

For example, the method may comprise, based on identifying that another threshold time elapses since obtaining the plurality of first values while identifying whether the extended range is maintained until the threshold time elapses, determining, using a minimum value of the plurality of first values, the reference position. The method may further comprise determining, using the reference position, the direction in which the camera faces.

For example, each of the plurality of the first values may indicate a height of a bounding box defined along a boundary of a visual object corresponding to the second vehicle in each of the plurality of images. The position values may indicate a central point of the bounding box.

For example, the method may comprise, based on obtaining a position value from among the plurality of position values, cancelling a noise component of a route represented by the plurality of position values by adjusting the obtained position value using a weighted sum of at least one position value from among the obtained position value and the plurality of position values obtained before the obtained position value.

For example, the reference position may be a first reference position. The method may comprise, based on identifying that the range is extended in accordance with obtaining a value higher than all the second values or lower than all the second values as the second values of the range after the range is maintained until the threshold time elapses, identifying whether the extended range including third values is maintained until the threshold time elapses. The third values may be continually obtained while the plurality of first values are obtained, may be a portion of the plurality of first values, and may include the second values. The method may comprise, based on the range maintained until the threshold time elapses, determining, using the position values respectively related to the third values, a second reference position of the second vehicle separated from the first vehicle by the reference distance. The method may comprise determining, using the first reference position of the second vehicle and the second reference position of the second vehicle, the direction in which the camera faces.

For example, the method may comprise identifying a reference line applied with respect to at least a portion of the plurality images by connecting the first reference position of the second vehicle to the second reference position of the second vehicle. The method may comprise determining the direction in which the camera faces in accordance with the reference line applied with respect to the at least a portion of the plurality of images.

For example, the method may comprise performing noise cancelling by a statistical method for determining the first reference position of the second vehicle and the second reference position of the second vehicle.

For example, the range may be a first range. The reference position may be a first reference position. The method may comprise obtaining, using the plurality of images, a plurality of third values indicating a size of a third vehicle different from the first vehicle and the second vehicle. The method may comprise identifying whether a second range, including fourth values that are a portion of the plurality of third values continually obtained while the plurality of third values are obtained, is maintained until the threshold time elapses. The method may comprise, based on identifying that the second range is maintained until the threshold time elapses, determining, using position values of the third vehicle respectively related to the fourth values, a second reference position of the third vehicle separated from the first vehicle by the reference distance. The method may comprise, based on identifying that the second range is maintained until the threshold time elapses, determining, using the first reference position of the second vehicle and the second refence position of the third vehicle, the direction in which the camera faces.

For example, the method may comprise identifying a reference line applied with respect to at least a portion of the plurality of images by connecting the first reference position of the second vehicle and the second reference position of the third vehicle. The method may comprise determining the direction in which the camera faces along the reference line applied with respect to the at least a portion of the plurality of images.

For example, the method may comprise performing noise cancelling by a statistical method for determining the first reference position of the second vehicle and the second reference position of the third vehicle.

For example, the method may comprise identifying whether the direction in which the camera faces is included in a reference range. The method may comprise, based on the direction different from the reference range, providing information to change a posture of the camera.

For example, the method may comprise, based on the direction included in the reference range, refraining from providing the information.

For example, the method may comprise controlling a display of the electronic device or a display device connected to the electronic device for displaying guidance to change the posture of the camera.

For example, the method may comprise controlling a speaker of the electronic device for outputting the guidance to change the posture of the camera.

As described above, a method may be executed in an electronic device comprising a camera. The method may comprise, while a relative distance between a first vehicle including the electronic device and a second vehicle different from the first vehicle, obtaining, using the camera, a plurality of images. The method may comprise obtaining, using the plurality of images obtained using the camera, a plurality of first values indicating a size of the second vehicle. The method may comprise identifying whether a range including second values is maintained until a threshold time elapses, wherein the second values are a portion of the plurality of the first values and are continually obtained while the plurality of the first values are obtained. The method may comprise, based on identifying that the range is maintained until the threshold time elapses, determining a direction in which the camera faces using a reference position obtained using the range. The method may comprise, based on identifying that the range is maintained until the threshold time elapses, providing information to change a posture of the camera in accordance with the determined direction. The method may comprise, based on identifying that the range is extended in accordance with obtaining a value higher than all the second values or lower than all the second values as a value from among the plurality of first values before the threshold time elapses, delaying determining the direction in which the camera faces.

For example, the method may comprise, based on obtaining a value from among position values of the second vehicle respectively related to the second values, cancelling a noise component of a route represented by the position values using a weighted sum of at least one position value from among the obtained position value and position values obtained before the obtained position value.

For example, the reference position may be a first reference position. The method may comprise, based on identifying that the range is extended in accordance with obtaining a value higher than all the second values or lower than all the second values after the range is maintained until the threshold time elapses, identifying whether the extended range including third values is maintained until the threshold time elapses. The third values may be continually obtained while the plurality of first values are obtained, may be a portion of the plurality of first values, and may include the second values. The method may comprise, based on identifying that the range is maintained until the threshold time elapses, determining the direction in which the camera faces using the first reference position and a second reference position obtained using the extended range. The method may comprise, based on identifying that the range is maintained until the threshold time elapses, providing the information to change the posture of the camera in accordance with the determined direction. The method may comprise, based on identifying that the extended range is extended in accordance with obtaining a value higher than all the third values or lower than all the third values as a value from among the plurality of first values before the threshold time elapses, delay determining the direction in which the camera faces.

For example, the range may be a first range. The reference position may be a first reference position. The method may comprise obtaining, using the plurality of images, a plurality of third values indicating a size of a third vehicle different from the first vehicle and the second vehicle. The method may comprise identifying whether a second range, including fourth values that are a portion of the plurality of third values and are continually obtained while the plurality of third values are obtained, is maintained until the threshold time elapses. The method may comprise, based on identifying that the second range is maintained until the threshold time elapses, determining the direction in which the camera faces using the first reference position obtained using the first range and a second reference position obtained using the second range. The method may comprise providing the information to change the posture of the camera in accordance with the determined direction. The method may comprise, based on identifying that the second range is extended in accordance with obtaining a value higher than all the fourth values or lower than all the fourth values as a value from among the plurality of third values before the threshold time elapses, delaying determining the direction in which the camera faces.

As described above, a non-transitory computer-readable storage medium may store one or more programs. The one or more programs, when executed by an electronic device having a camera, may comprise instructions that cause the electronic device to, while a relative distance between a first vehicle including the electronic device and a second vehicle different from the first vehicle is changed, obtain, using the camera, a plurality of images. The one or more programs may comprise instructions that cause the electronic device to obtain, using the plurality of images obtained using the camera, a plurality of first values indicating a size of the second vehicle. The one or more programs may comprise instructions that cause the electronic device to identify whether a range including second values is maintained until a threshold time elapses, wherein the second values are a portion of the plurality of the first values and are continually obtained while the plurality of the first values are obtained. The one or more programs may comprise instructions that cause the electronic device to, based on the range maintained until the threshold time elapses, determine, using position values of the second vehicle respectively related to the second values, a reference position of the second vehicle separated from the first vehicle by a reference distance. The one or more programs may comprise instructions that cause the electronic device to, determine, using the reference position, a direction in which the camera faces.

For example, the one or more programs may comprise instructions that cause the electronic device to, based on identifying that the range is extended in accordance with obtaining a value higher than all the second values or lower than all the second values before the threshold time elapses, delay determining the direction in which the camera faces by identifying whether the extended range, including another portion of the plurality of first values that are continually obtained, is maintained until the threshold time elapses. The value higher than all the second values or lower than all the second values may be included in the another portion of the plurality of first values.

For example, the one or more programs may comprise instructions that cause the electronic device to, based on identifying that another threshold time elapses since obtaining the plurality of first values while identifying whether the extended range is maintained until the threshold time elapses, determine, using a minimum value of the plurality of first values, the reference position. The one or more programs may comprise instructions that cause the electronic device to determine, using the reference position, the direction in which the camera faces.

For example, each of the plurality of the first values may indicate a height of a bounding box defined along a boundary of a visual object corresponding to the second vehicle in each of the plurality of images, and the position values may indicate a central point of the bounding box.

For example, the one or more programs may comprise instructions that cause the electronic device to, based on obtaining a position value from among the position values, cancel a noise component of a route represented by the position values using a weighted sum of at least one position value from among the obtained position value and position values obtained before the obtained position value.

For example, the reference position may be a first reference position. The one or more programs may comprise instructions that cause the electronic device to, based on identifying that the range is extended in accordance with obtaining a value higher than all the second values or lower than all the second values as the second values of the range after the range is maintained until the threshold time elapses, identify whether the extended range including third values is maintained until the threshold time elapses. The third values may be continually obtained while the plurality of first values are obtained, may be a portion of the plurality of first values, and may include the second values. The one or more programs may comprise instructions that cause the electronic device to, based on the range maintained until the threshold time elapses, determine, using the position values respectively related to the third values, a second reference position of the second vehicle separated from the first vehicle by the reference distance. The one or more programs may comprise instructions that cause the electronic device to determine, using the first reference position of the second vehicle and the second reference position of the second vehicle, the direction in which the camera faces.

For example, the one or more programs may comprise instructions that cause the electronic device to identify a reference line applied with respect to at least a portion of the plurality images by connecting the first reference position of the second vehicle to the second reference position of the second vehicle. The one or more programs may comprise instructions that cause the electronic device to determine the direction in which the camera faces in accordance with the reference line applied with respect to the at least one portion of the plurality of images.

For example, the one or more programs may comprise instructions that cause the electronic device to perform noise cancelling by a statistical method for determining the first reference position of the second vehicle and the second reference position of the second vehicle.

For example, the range may be a first range. The reference position may be a first reference position. The one or more programs may comprise instructions that cause the electronic device to obtain, using the plurality of images, a plurality of third values indicating a size of a third vehicle different from the first vehicle and the second vehicle. The one or more programs may comprise instructions that cause the electronic device to identify whether a second range, including fourth values that are a portion of the plurality of third values continually obtained while the plurality of third values are obtained, is maintained until the threshold time elapses. The one or more programs may comprise instructions that cause the electronic device to, based on identifying that the second range is maintained until the threshold time elapses, determine, using position values of the third vehicle respectively related to the fourth values, a second reference position of the third vehicle separated from the first vehicle by the reference distance. The one or more programs may comprise instructions that cause the electronic device to, based on identifying that the second range is maintained until the threshold time elapses, determine, using the first reference position of the second vehicle and the second refence position of the third vehicle, the direction in which the camera faces.

For example, the one or more programs may comprise instructions that cause the electronic device to identify a reference line applied with respect to at least a portion of the plurality of images by connecting the first reference position of the second vehicle and the second reference position of the third vehicle. The one or more programs may comprise instructions that cause the electronic device to determine the direction in which the camera faces along the reference line applied with respect to the at least a portion of the plurality of images.

For example, the one or more programs may comprise instructions that cause the electronic device to perform noise cancelling by a statistical method for determining the first reference position of the second vehicle and the second reference position of the third vehicle.

For example, the one or more programs may comprise instructions that cause the electronic device to identify whether the direction in which the camera faces is included in a reference range. The one or more programs may comprise instructions that cause the electronic device to, based on the direction different from the reference range, provide information to change a posture of the camera.

For example, the one or more programs may comprise instructions that cause the electronic device to, based on the direction included in the reference range, refrain from providing the information.

For example, the one or more programs may comprise instructions that cause the electronic device to control a display of the electronic device or a display device connected to the electronic device for displaying guidance to change the posture of the camera.

For example, the one or more programs may comprise instructions that cause the electronic device to control a speaker of the electronic device for outputting the guidance to change the posture of the camera.

As described above, a non-transitory computer-readable storage medium may store one or more programs. The one or more programs, when executed by an electronic device having a camera, may comprise instructions that cause the electronic device to, while a relative distance between a first vehicle including the electronic device and a second vehicle different from the first vehicle, obtain, using the camera, a plurality of images. The one or more programs may comprise instructions that cause the electronic device to obtain, using the plurality of images obtained using the camera, a plurality of first values indicating a size of the second vehicle. The one or more programs may comprise instructions that cause the electronic device to identify whether a range including second values is maintained until a threshold time elapses, wherein the second values are a portion of the plurality of the first values and are continually obtained while the plurality of the first values are obtained. The one or more programs may comprise instructions that cause the electronic device to, based on identifying that the range is maintained until the threshold time elapses, determine a direction in which the camera faces using a reference position obtained using the range. The one or more programs may comprise instructions that cause the electronic device to, based on identifying that the range is maintained until the threshold time elapses, provide information to change a posture of the camera in accordance with the determined direction. The one or more programs may comprise instructions that cause the electronic device to, based on identifying that the range is extended in accordance with obtaining a value higher than all the second values or lower than all the second values as a value from among the plurality of first values before the threshold time elapses, delay determining the direction in which the camera faces.

For example, the one or more programs may comprise instructions that cause the electronic device to, based on obtaining a value from among position values of the second vehicle respectively related to the second values, cancel a noise component of a route represented by the position values using a weighted sum of at least one position value from among the obtained position value and position values obtained before the obtained position value.

For example, the reference position may be a first reference position. The one or more programs may comprise instructions that cause the electronic device to, based on identifying that the range is extended in accordance with obtaining a value higher than all the second values or lower than all the second values after the range is maintained until the threshold time elapses, identify whether the extended range including third values is maintained until the threshold time elapses. The third values may be continually obtained while the plurality of first values are obtained, may be a portion of the plurality of first values, and may include the second values. The one or more programs may comprise instructions that cause the electronic device to, based on identifying that the second range is maintained until the threshold time elapses, determine the direction in which the camera faces using the first reference position obtained using the first range and a second reference position obtained using the second range. The one or more programs may comprise instructions that cause the electronic device to, based on identifying that the second range is maintained until the threshold time elapses, provide the information to change the posture of the camera in accordance with the determined direction. The one or more programs may comprise instructions that cause the electronic device to, based on identifying that the second range is extended in accordance with obtaining a value higher than all the third values or lower than all the third values as a value from among the plurality of first values before the threshold time elapses, delay determining the direction in which the camera faces.

For example, the range may be a first range. The reference position may be a first reference position. The one or more programs may comprise instructions that cause the electronic device to obtain, using the plurality of images, a plurality of third values indicating a size of a third vehicle different from the first vehicle and the second vehicle. The one or more programs may comprise instructions that cause the electronic device to identify whether a second range, including fourth values that are a portion of the plurality of third values and are continually obtained while the plurality of third values are obtained, is maintained until the threshold time elapses. The one or more programs may comprise instructions that cause the electronic device to, based on identifying that the second range is maintained until the threshold time elapses, determine the direction in which the camera faces using the first reference position obtained using the first range and a second reference position obtained using the second range. The one or more programs may comprise instructions that cause the electronic device to, based on identifying that the second range is maintained until the threshold time elapses, provide the information to change the posture of the camera in accordance with the determined direction. The one or more programs may comprise instructions that cause the electronic device to, based on identifying that the second range is extended in accordance with obtaining a value higher than all the fourth values or lower than all the fourth values as a value from among the plurality of third values before the threshold time elapses, delay determining the direction in which the camera faces.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory, storing instructions, comprising one or more storage media;
a camera; and
at least one processor comprising processing circuitry,
wherein the instructions, when executed by the at least one processor individually or collectively, cause the electronic device to:
while a relative distance between a first vehicle including the electronic device and a second vehicle different from the first vehicle is changed, obtain, using the camera, a plurality of images;
obtain, using the plurality of images obtained using the camera, a plurality of first values indicating a size of the second vehicle;
identify whether a range including second values is maintained until a threshold time elapses, wherein the second values are a portion of the plurality of the first values and are continually obtained while the plurality of the first values are obtained;
based on the range maintained until the threshold time elapses:
determine, using position values of the second vehicle respectively related to the second values, a reference position of the second vehicle separated from the first vehicle by a reference distance, and
determine, using the reference position, a direction in which the camera faces.

2. The electronic device of claim 1,
wherein the instructions, when executed by the at least one processor individually or collectively, cause the electronic device to:
based on identifying that the range is extended in accordance with obtaining a value higher than all the second values or lower than all the second values before the threshold time elapses, delay determining the direction in which the camera faces by identifying whether the extended range, including another portion of the plurality of first values that are continually obtained, is maintained until the threshold time elapses, and
wherein the value higher than all the second values or lower than all the second values is included in the another portion of the plurality of first values.

3. The electronic device of claim 2,
wherein the instructions, when executed by the at least one processor individually or collectively, cause the electronic device to:
based on identifying that another threshold time elapses since obtaining the plurality of first values while identifying whether the extended range is maintained until the threshold time elapses, determine, using a minimum value of the plurality of first values, the reference position; and
determine, using the reference position, the direction in which the camera faces.

4. The electronic device of claim 1,
wherein each of the plurality of the first values indicate a height of a bounding box defined along a boundary of a visual object corresponding to the second vehicle in each of the plurality of images, and
wherein the position values indicate a central point of the bounding box.

5. The electronic device of claim 1,
wherein the instructions, when executed by the at least one processor individually or collectively, cause the electronic device to:
based on obtaining a position value from among the position values, cancel a noise component of a route represented by the position values using a weighted sum of at least one position value from among the obtained position value and position values obtained before the obtained position value.

6. The electronic device of claim 1,
wherein the reference position is a first reference position,
wherein the instructions, when executed by the at least one processor individually or collectively, cause the electronic device to:
based on identifying that the range is extended in accordance with obtaining a value higher than all the second values or lower than all the second values as the second values of the range after the range is maintained until the threshold time elapses, identify whether the extended range including third values is maintained until the threshold time elapses, wherein the third values are continually obtained while the plurality of first values are obtained, are a portion of the plurality of first values, and include the second values;
based on the range maintained until the threshold time elapses:
determine, using the position values respectively related to the third values, a second reference position of the second vehicle separated from the first vehicle by the reference distance; and
determine, using the first reference position of the second vehicle and the second reference position of the second vehicle, the direction in which the camera faces, and
wherein the value higher than all the second values or lower than all the second values is included in the third values of the plurality of first values.

7. The electronic device of claim 6,
wherein the instructions, when executed by the at least one processor individually or collectively, cause the electronic device to:
identify a reference line applied with respect to at least a portion of the plurality of images by connecting the first reference position of the second vehicle to the second reference position of the second vehicle; and
determine the direction in which the camera faces in accordance with the reference line applied with respect to the at least a portion of the plurality of images.

8. The electronic device of claim 6
wherein the instructions, when executed by the at least one processor individually or collectively, cause the electronic device to:
perform noise cancelling by a statistical method for determining the first reference position of the second vehicle and the second reference position of the second vehicle.

9. The electronic device of claim 1,
wherein the range is a first range,
wherein the reference position is a first reference position,
wherein the instructions, when executed by the at least one processor individually or collectively, cause the electronic device to:
obtain, using the plurality of images, a plurality of third values indicating a size of a third vehicle different from the first vehicle and the second vehicle;
identify whether a second range, including fourth values that are a portion of the plurality of third values and are continually obtained while the plurality of third values are obtained, is maintained until the threshold time elapses;
based on identifying that the second range is maintained until the threshold time elapses;
determine, using position values of the third vehicle respectively related to the fourth values, a second reference position of the third vehicle separated from the first vehicle by the reference distance; and
determine, using the first reference position of the second vehicle and the second refence position of the third vehicle, the direction in which the camera faces.

10. The electronic device of claim 9,
wherein the instructions, when executed by the at least one processor individually or collectively, cause the electronic device to:
identify a reference line applied with respect to at least a portion of the plurality of images by connecting the first reference position of the second vehicle and the second reference position of the third vehicle; and
determine the direction in which the camera faces along the reference line applied with respect to the at least a portion of the plurality of images.

11. The electronic device of claim 9,
wherein the instructions, when executed by the at least one processor individually or collectively, cause the electronic device to:
perform noise cancelling by a statistical method for determining the first reference position of the second vehicle and the second reference position of the third vehicle.

12. The electronic device of claim 1,
wherein the instructions, when executed by the at least one processor individually or collectively, cause the electronic device to:
identify whether the direction in which the camera faces is included in a reference range; and
based on the direction out of the reference range, provide information to change a posture of the camera.

13. The electronic device of claim 12,
wherein the instructions, when executed by the at least one processor individually or collectively, cause the electronic device to:
based on the direction included in the reference range, refrain from providing the information.

14. The electronic device of claim 12,
wherein the instructions, when executed by the at least one processor individually or collectively, cause the electronic device to:
control a display of the electronic device or a display device connected to the electronic device for displaying guidance to change the posture of the camera.

15. The electronic device of claim 12,
wherein the instructions, when executed by the at least one processor individually or collectively, cause the electronic device to:
control a speaker of the electronic device for outputting the guidance to change the posture of the camera.

16. An electronic device comprising:
memory, storing instructions, comprising one or more storage media;
a camera; and
at least one processor comprising processing circuitry,
wherein the instructions, when executed by the at least one processor individually or collectively, cause the electronic device to:
while a relative distance between a first vehicle including the electronic device and a second vehicle different from the first vehicle, obtain, using the camera, a plurality of images;
obtain, using the plurality of images obtained using the camera, a plurality of first values indicating a size of the second vehicle;
identify whether a range including second values is maintained until a threshold time elapses, wherein the second values are a portion of the plurality of the first values and are continually obtained while the plurality of the first values are obtained;
based on identifying that the range is maintained until the threshold time elapses:
determine a direction in which the camera faces using a reference position obtained using the range, and
provide information to change a posture of the camera in accordance with the determined direction; and
based on identifying that the range is extended in accordance with obtaining a value higher than all the second values or lower than all the second values as a value from among the plurality of first values before the threshold time elapses, delay determining the direction in which the camera faces.

17. The electronic device of claim 16,
wherein the instructions, when executed by the at least one processor individually or collectively, cause the electronic device to:
based on obtaining a value from among position values of the second vehicle respectively related to the second values, cancel a noise component of a route represented by the position values using a weighted sum of at least one position value from among the obtained position value and position values obtained before the obtained position value.

18. The electronic device of claim 16,
wherein the reference position is a first reference position,
wherein the instructions, when executed by the at least one processor individually or collectively, cause the electronic device to:
based on identifying that the range is extended in accordance with obtaining a value higher than all the second values or lower than all the second values after the range is maintained until the threshold time elapses, identify whether the extended range including third values is maintained until the threshold time elapses, wherein the third values are continually obtained while the plurality of first values are obtained, are a portion of the plurality of first values, and include the second values;
based on identifying that the range is maintained until the threshold time elapses:
determine the direction in which the camera faces using the first reference position and a second reference position obtained using the extended range; and
provide the information to change the posture of the camera in accordance with the determined direction, and
based on identifying that the extended range is extended in accordance with obtaining a value higher than all the third values or lower than all the third values as a value from among the plurality of first values before the threshold time elapses, delay determining the direction in which the camera faces.

19. The electronic device of claim 16,
wherein the range is a first range,
wherein the reference position is a first reference position,
wherein the instructions, when executed by the at least one processor individually or collectively, cause the electronic device to:
obtain, using the plurality of images, a plurality of third values indicating a size of a third vehicle different from the first vehicle and the second vehicle;
identify whether a second range, including fourth values that are a portion of the plurality of third values and are continually obtained while the plurality of third values are obtained, is maintained until the threshold time elapses;
based on identifying that the second range is maintained until the threshold time elapses:
determine the direction in which the camera faces using the first reference position obtained using the first range and a second reference position obtained using the second range; and
provide the information to change the posture of the camera in accordance with the determined direction; and
based on identifying that the second range is extended in accordance with obtaining a value higher than all the fourth values or lower than all the fourth values as a value from among the plurality of third values before the threshold time elapses, delay determining the direction in which the camera faces.

20. A method executed in an electronic device comprising a camera, the method comprising:
while a relative distance between a first vehicle including the electronic device and a second vehicle different from the first vehicle is changed, obtaining, using the camera, a plurality of images;
obtaining, using the plurality of images obtained using the camera, a plurality of first values indicating a size of the second vehicle;
identifying whether a range including second values is maintained until a threshold time elapses, wherein the second values are a portion of the plurality of the first values and are continually obtained while the plurality of the first values are obtained;
based on the range maintained until the threshold time elapses:
determining, using position values of the second vehicle respectively related to the second values, a reference position of the second vehicle separated from the first vehicle by a reference distance, and
determining, using the reference position, a direction in which the camera faces.
